(19) United States
(12) Patent Application Publication
(10) Pub. No.: US 2011/0171431 A1
(43) Pub. Date: Jul. 14, 2011

(54) FINE STRUCTURE AND STAMPER FOR IMPRINTING

(76) Inventors: Masahiko Ogino, Hitachi (JP); Takashi Ando, Hitachi (JP); Miho Sasaki, Mito (JP); Akihiro Miyauchi, Hitachi (JP)

(21) Appl. No.: 13/002,209

(22) PCT Filed: Jun. 18, 2009
(86) PCT No.: PCT/JP2009/002773

§ 371 Date: Apr. 1, 2011

(30) Foreign Application Priority Data
Jun. 30, 2008 (JP) 2008169768
Jun. 30, 2008 (JP) 2008169772

(51) Int. Cl. B32B 3/30; B05D 3/12

(52) U.S. Cl. 428/172; 427/358

(57) ABSTRACT

Provided is a fine structure which allows the formation of a highly accurate metallic replica mold. The structure is resistant to breakage even in the presence of foreign particles or bumps and causes a smaller transfer failure region even when applied to an undulating object to be transferred. Also provided is a stamper for imprinting, which conforms to local bumps of a substrate to be transferred, causes, if any, a smaller pattern transfer failure region, and has satisfactory durability.

The fine structure includes a supporting member; and a pattern layer having a fine asperity pattern formed on a surface thereof. The pattern layer is made from a resin through curing of a resin composition containing a cationic-polymerization catalyst and two or more organic components having different functional groups, and the supporting member and the pattern layer each transmit light having a wavelength of 365 nm or longer. The stamper for imprinting includes a base layer; a buffer layer; and a pattern layer having a fine asperity geometry formed on a surface thereof. The stamper is adopted to transferring of the asperity geometry to a surface of an object to be transferred by contacting the pattern layer with the object to be transferred. The buffer layer is arranged on another surface of the pattern layer opposite to the surface on which the asperity geometry is formed, and the base layer is arranged on another surface of the buffer layer opposite to the surface on which the pattern layer is arranged. The buffer layer has a Young's modulus lower than the Young's modulus of the pattern layer, and the base layer has a Young's modulus higher than the Young's modulus of the buffer layer.

### TECHNICAL FIELD

The present invention relates to a fine structure and a stamper for imprinting.

### BACKGROUND ART

A photolithography technique has been frequently used as a technique for processing fine patterns needed typically in semiconductor devices. However, with miniaturization of the patterns as small as the wavelength of a light source used for the exposure, it becomes difficult to process such fine patterns by the photolithography technique. For this reason, an electron beam lithography system that is a kind of a charged particle beam apparatus has been used instead of the photolithography technique. Such a pattern formation using electron beams is a technique of directly writing a mask pattern, which is different from a patterning method of a full plate exposure method using a light source such as i-ray or excimer laser beams. Therefore, there is a disadvantage that an exposure time (writing time) increases with an increasing number of patterns to be written. Accordingly, it requires a long time to complete the patterning. As a result, with an increasing degree of integration of a semiconductor integrated circuit, a time required for the patterning increases, which may result in a poor throughput.

To avoid such disadvantage and to speed up pattering with an electron beam lithography system, an electron beam cell projection lithography technique has been developed, in which electron beams are irradiated en bloc on a plurality of combined masks in various shapes to form a complex-shaped beam. However, with miniaturization of the patterns, this technique suffers from many factors which raise the system cost, such as increase in size of the electron beam lithography system and increase in accuracy of mask alignment.

In contrast, a nanoimprint technique is well known as a technique for accurately forming a fine pattern at low cost. In this nanoimprint technique, the fine pattern can be formed on a resin layer of an object by pressing a stamper against the object, the stamper having concavities and convexities (a surface configuration) corresponding to concavities and convexities of a pattern to be formed, and the object being obtained typically by forming the resin layer on a predetermined substrate. This nanoimprint technique is believed to form a fine structure having a size of 25 nanometers or less through transfer using a silicon wafer as a mold.

The patterned resin layer (hereinafter also referred to as “pattern-formed layer”) includes a thin film layer (residual layer) arranged on a substrate; and a pattern layer arranged on the thin film layer and composed of convexities. The nanoimprint technique is considered to apply to formation of recording bits in mass storage media, and patterning in semiconductor integrated circuits.

Patent Literature 1 discloses a method for producing a replica mold having a fine pattern. The method includes the first step of applying a layer of photoreactive post-curable resin composition to an elastic supporting member having a thickness of 0.5 mm to 5 cm to give a mold material, the resin composition having a viscosity before curing of 10 to 10000 cps and a glass transition temperature after curing of 30° C. or lower; the second step of irradiating the mold material with an ultraviolet ray and pressing the irradiated photoreactive post-curable resin composition layer against a fine pattern on a surface of the master mold before the conversion from the photoreactive post-curable resin composition becomes more than 30%; the third step of releasing the mold material from the master mold after completion of curing of the photoreactive post-curable resin composition to give a mother pattern; the fourth step of sequentially laying a layer of curable resin composition and a mold supporting member on the mother pattern, the curable resin composition having a viscosity of 10 to 10000 cps and a glass transition temperature after curing of 100° C. or higher, and the mold supporting member having a thickness of 0.5 mm to 5 cm; and the fifth step of curing the curable resin composition and releasing the cured curable resin composition layer and the mold supporting member integrally from the mother pattern to give a replica mold. This method is intended to provide a method for easily producing a replica mold which is usable as a nanoimprinting stamper typically for the production of even a fine structure having a large aspect ratio, a fine structure having a little draft angle, and a fine structure having a large area.

Patent Literature 2 discloses a polymer stamp for use in an imprint process, the polymer stamp including a polymer film having a surface on which a structured pattern is formed, wherein the polymer film is made of a material comprising one or more Cyclic Olefin Copolymers (COCs). This polymer stamp is intended to provide a solution for an improved imprint process, having high replication fidelity and being easy and suitable to employ industrially.

### PRIOR ART DOCUMENTS

### Patent Documents

Patent Literature 1: Japanese Patent Application Laid-Open No. 2007-245684
Patent Literature 2: Japanese Patent Application Laid-Open No. 2007-55235

### SUMMARY OF THE INVENTION

### Object to be Achieved by the Invention

An object of the present invention is to provide a resinous replica mold for nanoimprinting, which can give a highly accurate metallic replica mold, is resistant to breakage even in the presence of foreign particles and/or bumps, and causes, if any, a smaller transfer failure region even when adopted to an undulating object to be transferred.

Another object of the present invention is to provide a stamper for imprinting and a method for imprinting, both of which enable good conformity with local bumps of a substrate to be transferred, whereby minimize a pattern transfer failure region, are resistant to breakage of the stamper upon transferring, and show satisfactory alignment accuracy.

### Means for Achieving the Object

A fine structure of the present invention includes a supporting member; and a pattern layer having a fine asperity pattern formed on a surface thereof on the surface of the supporting member, and is characterized in that the pattern layer is made from a resin through curing of a resin composition containing a cationic-polymerization catalyst and two or more organic components having different functional groups, and the supporting member and the pattern layer each transmit light having a wavelength of 365 nm or longer.

A stamper for imprinting of the present invention includes a base layer; a buffer layer; and a pattern layer having a fine asperity geometry formed on a surface thereof, the stamper adopted to transferring of the asperity geometry to a surface of a object to be transferred by contacting the pattern layer with the object to be transferred, and is characterized in that the buffer layer is arranged on another surface of the pattern layer opposite to the surface on which the asperity geometry is formed, the base layer is arranged on another surface of the buffer layer opposite to the surface on which the pattern layer is arranged, the buffer layer has a Young's modulus lower than the Young's modulus of the pattern layer, and the base layer has a Young's modulus higher than the Young's modulus of the buffer layer.

### Effect of the Invention

A highly accurate metallic replica mold can be formed by using the fine structure according to the present invention because the pattern layer thereof has a glass transition temperature (Tg) equal to or higher than the temperature for the formation of the metallic replica. Further, a structure containing the buffer layer between the pattern layer and the supporting member can provide a resinous replica mold for nanoimprinting which is resistant to breakage even when foreign particles and/or bumps are present in the layer, and which causes a smaller transfer failure region even when adopted to an undulating object to be transferred.

The present invention provides a stamper for imprinting and a method for imprinting, both of which enable good conformity with local bumps of a substrate to be transferred, whereby minimize a pattern transfer failure region, and are resistant to failure of the stamper upon transferring.

### BRIEF DESCRIPTION OF THE DRAWINGS

FIG. 1 depicts schematic cross-sectional views illustrating a production process of a fine structure according to an embodiment of the present invention.

FIG. 2 depicts schematic cross-sectional views illustrating a production process of a fine structure according to another embodiment of the present invention.

FIG. 3 depicts schematic cross-sectional views illustrating a pattern transfer step using the fine structure according to the present invention.

FIG. 4 is a perspective view illustrating schematic structures of a stamper according to an embodiment of the present invention and a resin to be transferred.

FIG. 5 is a graph showing the relation between bump conformity of a stamper according to the present invention and the Young's modulus of a buffer layer.

FIG. 6 is a graph showing the relation between the bump conformity of the stamper according to the present invention and a thickness of the buffer layer.

FIG. 7 is a graph showing the relation between the bump conformity of the stamper according to the present invention and a thickness of the pattern layer.

FIG. 8 depicts schematic cross-sectional views illustrating a pattern transferring step according to an embodiment of the present invention.

FIG. 9 depicts schematic cross-sectional views illustrating the structure of stampers according to embodiments of the present invention.

FIG. 10 is a perspective view schematically illustrating the structure of a stamper for use in an imprinting process according to the present invention.

FIG. 11 depicts schematic cross-sectional views illustrating an imprinting process according to an embodiment of the present invention.

FIG. 12 depicts schematic cross-sectional views illustrating an imprinting process according to another embodiment of the present invention.

FIG. 13 depicts schematic cross-sectional views illustrating a micropatterning process through nanoimprinting according to the present invention.

FIG. 14 is a schematic cross-sectional view showing bump conformity of a resin to be transferred according to an embodiment of the present invention.

### MODE FOR CARRYING OUT THE INVENTION

The present invention relates to a microtransferring mold having a fine asperity pattern on a surface thereof for forming a fine asperity pattern on a surface of an object to be transferred by pressing the microtransferring mold against the object to be transferred.

The present invention further relates to a stamper for imprinting and a method for imprinting, both of which transfer fine asperity geometry of the stamper to the surface of the object to be transferred.

A fine structure according to the present invention includes a supporting member; and a pattern layer having a fine asperity pattern formed on a surface thereof on the surface of the supporting member, and is characterized in that the pattern layer is made from a resin through curing of a resin composition containing a cationic-polymerization catalyst and two or more organic components differing in functional group, and the supporting member and pattern layer each transmit light having a wavelength of 365 nm or longer.

The above fine structure is characterized in that the organic components in the resin composition each have at least one functional group selected from the group consisting of epoxy groups, oxetanyl groups and vinyl ether groups.

The above fine structure is characterized in that the resin composition preferably contains substantially no solvent component.

The above fine structure is characterized in that the organic components in the resin composition each have two or more functional groups per one molecule.

The above fine structure is characterized in that one of the organic components in the resin composition is preferably represented by following Structural Formula (1):

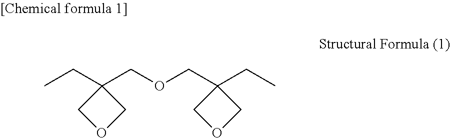

The above fine structure is characterized in that the cationic-polymerization catalyst initiates curing of the resin composition by the action of ultraviolet rays.

The above fine structure is characterized in that the pattern layer preferably has a glass transition temperature of 50° C. or higher.

The above fine structure is characterized by further including a release layer on the surface of the pattern layer.

A fine structure according to the present invention includes a supporting member; a buffer layer; and a pattern layer having a fine asperity pattern formed on a surface thereof, and is characterized in that the buffer layer is arranged between the supporting member and the pattern layer, the pattern layer is made from a resin through curing of a resin composition containing a cationic-polymerization catalyst and two or more organic components differing in functional group, and the supporting member, the buffer layer and the pattern layer each transmit light having a wavelength of 365 nm or longer.

The above fine structure is characterized in that the organic components in the resin composition just mentioned above may each have at least one functional group selected from the group consisting of epoxy groups, oxetanyl groups and vinyl ether groups.

The above fine structure is characterized in that the resin composition may contain substantially no solvent component.

The above fine structure is characterized in that the organic components in the resin composition may each have two or more functional groups per one molecule.

The above fine structure is characterized in that one of the organic components in the resin composition is preferably represented by the above Structural Formula (1).

The above fine structure is characterized in that the cationic-polymerization catalyst initiates curing of the resin composition by the action of ultraviolet rays.

The above fine structure is characterized in that the buffer layer preferably has an elastic modulus lower than the elastic modulus of the pattern layer.

The above fine structure is characterized in that the buffer layer preferably has a thickness larger than the thickness of the pattern layer.

The above fine structure is characterized in that the pattern layer preferably has a glass transition temperature of 60° C. or higher.

The above fine structure is characterized by further including a release layer on the surface of the pattern layer.

A method for producing a fine structure according to the present invention is a method for producing the fine structure including a supporting member and a pattern layer having a fine asperity pattern formed on a surface thereof on the surface of the supporting member, the pattern layer being made from a resin through curing of a resin composition containing a cationic-polymerization catalyst and two or more organic components differing in functional group, and is characterized by including the steps of applying the resin composition to a surface of the supporting member; pressing a master mold having fine concavities and convexities on a surface of the applied resin composition; curing the resin composition while pressing the master mold to thereby form the pattern layer; and detaching the master mold from the pattern layer.

A method for producing a fine structure according to the present invention is a method for producing the fine structure including a supporting member, a buffer layer and a pattern layer having a fine asperity pattern formed on a surface thereof, the pattern layer being made from a resin through curing of a resin composition containing a cationic-polymerization catalyst and two or more organic components differing in functional group, and is characterized by including the steps of applying the resin composition to a surface of the buffer layer after forming the buffer layer on a surface of the supporting member; pressing a master mold having fine concavities and convexities on a surface of the applied resin composition; curing the resin composition while pressing the master mold to thereby form the pattern layer; and detaching the master mold from the pattern layer.

A stamper for imprinting according to the present invention includes a base layer; a buffer layer; and a pattern layer having a fine asperity geometry formed on a surface thereof, being adopted to transferring of the asperity geometry to a surface of an object to be transferred by contacting the pattern layer with the object to be transferred, and is characterized in that the buffer layer is arranged on another surface of the pattern layer opposite to the surface on which the asperity geometry is formed, the base layer is arranged on another surface of the buffer layer opposite to the surface on which the pattern layer is arranged, the buffer layer has a Young's modulus lower than the Young's modulus of the pattern layer, and the base layer has a Young's modulus higher than the Young's modulus of the buffer layer.

The above stamper for imprinting is characterized in that the buffer layer has a thickness larger than the thickness of the pattern layer.

The above stamper for imprinting is characterized in that the base layer has a thickness larger than the thickness of the pattern layer.

The above stamper for imprinting is characterized in that the buffer layer has a Young's modulus of 1.5 GPa or less.

The above stamper for imprinting is characterized in that the buffer layer has a thickness of 4.2 μm or more.

The above stamper for imprinting is characterized in that the pattern layer has a thickness in the range of 100 nm to 43 μm.

The above stamper for imprinting is characterized in that the pattern layer is detachable from the buffer layer and exchangeable.

A stamper for imprinting according to the present invention includes a base layer; a buffer layer; and a pattern layer having a fine asperity geometry formed on a surface thereof, being adopted to transferring of the asperity geometry to a surface of an object to be transferred by contacting the pattern layer with the object to be transferred, and is characterized in that the buffer layer is arranged on another surface of the pattern layer opposite to the surface on which the asperity geometry is formed, the base layer is arranged on another surface of the buffer layer opposite to the surface on which the pattern layer is arranged, the stamper further includes an intermediate layer between the pattern layer and the buffer layer and/or between the buffer layer and the base layer, the buffer layer has a Young's modulus lower than the Young's modulus of the pattern layer, and the base layer has a Young's modulus higher than the Young's modulus of the buffer layer.

The above stamper for imprinting is characterized in that the buffer layer has a thickness larger than the thickness of the pattern layer.

The above stamper for imprinting is characterized in that the base layer has a thickness larger than the thickness of the pattern layer.

The above stamper for imprinting is characterized in that the intermediate layer has a Young's modulus lower than the Young's modulus of the pattern layer.

The above stamper for imprinting is characterized in that the intermediate layer has a thickness smaller than the thickness of the buffer layer.

The above stamper for imprinting is characterized in that the buffer layer has a Young's modulus of 1.5 GPa or less.

The above stamper for imprinting is characterized in that the buffer layer has a thickness of 4.2 μm or more.

The above stamper for imprinting is characterized in that the pattern layer has a thickness in the range of 100 nm to 43 μm.

The above stamper for imprinting is characterized by including an exchangeable unit including the pattern layer; and a reusable unit arranged on another surface of the exchangeable unit opposite to the surface on which the asperity geometry is formed, the reusable unit includes the base layer, and the exchangeable unit being detachable from the reusable unit and exchangeable.

The above stamper for imprinting is characterized by including the exchangeable unit, the reusable unit and an adhesive layer therebetween, in which the adhesive layer loses its adhesiveness by the action of heat or light.

The above stamper for imprinting is characterized in that the exchangeable unit and the reusable unit are in intimate contact and fixed with each other.

A method for imprinting according to the present invention includes a base layer and a pattern layer having a fine asperity geometry formed on a surface thereof on the surface of the base layer, has an exchangeable unit including the pattern layer; and a reusable unit including the base layer, and is a method for imprinting by contacting the pattern layer with an object to be transferred and transferring the asperity geometry to a surface of the object to be transferred, and is characterized by including the steps of a contacting step of contacting the pattern layer with the object to be transferred; a transferring step of pressing the pattern layer against the object to be transferred and whereby transferring the asperity geometry to the object to be transferred; a exchangeable unit detaching step of detaching the exchangeable unit from the reusable unit; a releasing step of releasing the exchangeable unit from the object to be transferred; and an another exchangeable unit sticking step of bringing another exchangeable unit into intimate contact with the reusable unit.

The above method for imprinting is characterized in that the exchangeable unit further includes an intermediate layer, the reusable unit includes a buffer layer having a Young's modulus lower than the Young's modulus of the pattern layer; and the base layer having a Young's modulus higher than the Young's modulus of the buffer layer, and the exchangeable unit detaching step is the step of detaching the intermediate layer from the reusable unit at the contact surface between them.

A stamper for imprinting according to the present invention uses the fine structure.

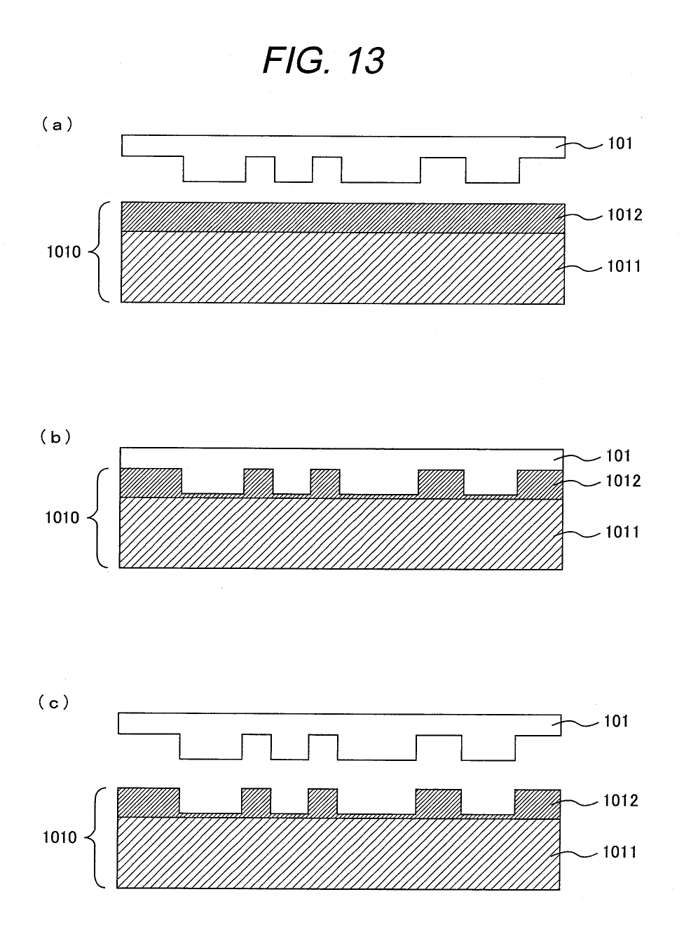

FIG. 13 depicts schematic views of an example of a nanoimprinting process. In this example, with reference to FIG. 13 (a), an object to be transferred 1010 and a stamper 101 are respectively fixed to stages (not shown), which stages can control the distance therebetween. The object to be transferred 1010 includes a substrate to be transferred 1011 and a resin to be transferred 1012 for patterning, arranged on a surface of the substrate to be transferred 1011. Next, the stages are driven to press the stamper 101 against the resin to be transferred 1012 as in FIG. 13 (b), and the resin to be transferred 1012 is cured. Then the stages are driven to detach the stamper 101 from the object to be transferred 1010, whereby an asperity pattern of the stamper 101 is transferred to the resin to be transferred 1012, as illustrated in FIG. 13 (c).

One of challenges in the imprint technique, which is believed to allow the formation of fine patterns, is a technique for preparing a finely patterned mold. Such a mold for imprinting is generally prepared on a quartz or silicon (Si) wafer according to the photolithography technique or electron beam writing technique. The resulting mold is therefore very expensive. In addition, when foreign particles or bumps, for example, are present on a substrate to be transferred, they may cause breakage of the expensive mold or may cause transferring failure in the vicinity of the foreign particles or bumps.

Patent Literature 1 discloses a technique for forming a resinous replica having a structure with a high aspect ratio by using an elastic article having a glass transition temperature (Tg) of 30° C. or lower as a replica mold material. To form a metallic replica made typically of nickel (Ni) using this resinous replica, electroconductive electrodes are formed on the resinous replica, and electroplating is then performed to form a replica mold for transferring.

After investigations about the preparation of a nickel replica mold using this technique, the present inventors have found that the shape of a nanoscale pattern is susceptible to the electroconductive electrode forming process; and that the electroconductive electrodes are formed in this process typically through sputtering-film-deposition or nonelectrolytic plating at a temperature higher than room temperature, and the pattern accuracy deteriorates if the resinous replica material has a glass transition temperature lower than the process temperature.

The present inventors have also found that bumps or foreign particles cause the breakage of the fine asperity pattern on the surface of the mold due to the pressure applied during transferring and cause a wide-ranging transfer failure region around the bumps or foreign particles if the bumps or foreign particles are present on the surface of the substrate when the pattern is transferred to a resin film formed on a Si wafer or another hard substrate using a silicon or quartz mold. The present inventors have further found that the mold cannot conform to or fit the undulation to thereby cause transferring failure if the substrate to be transferred has undulation on a surface thereof.

The nanoimprint technique may be adopted to a substrate to be transferred having bumps or foreign particles which are present locally on a surface thereof and which have a diameter or height of several tens of nanometers to several micrometers. In this case, if a non-flexible material is used as a material for the stamper or for the substrate to be transferred, an excessive pressure is applied to the peripheries of the local bumps or foreign particles to cause the breakage of the stamper or the substrate to be transferred. Such broken stamper is generally not reusable. In addition, the stamper does not conform to or fit the bumps or foreign particles and thereby causes a pattern transfer failure region around the bumps or foreign particles. The pattern transfer failure region is a region where the pattern is transferred incompletely or is not transferred.

As disclosed in Patent Literature 2, it is possible to prevent the breakage of a stamper and a substrate to be transferred by using a flexible material in the stamper to thereby disperse the pressure during imprinting. However, when pattern transferring with high accuracy on the order of several nanometers or alignment with high accuracy on the order of several micrometers is performed, the stamper as disclosed in Patent Literature 2 may fail to provide desired dimensional accuracy and registration. Accordingly, a demand has been made to provide a stamper which is resistant to breakage, which can conform to or fit bumps or foreign particles which whereby causes a smaller pattern transfer failure region, and which excels in alignment accuracy, even if present on the surface of the substrate to be transferred.

A fine structure according to a first embodiment of the present invention is a finely shaped structure which includes a supporting member; and a pattern layer having a fine asperity pattern formed on a surface thereof on the surface of the supporting member, in which the pattern layer is made from a resin through curing of a resin composition containing a cationic-polymerization catalyst and two or more organic components having different functional groups, and the supporting member and the pattern layer each transmit light having a wavelength of 365 nm or longer.

A fine structure according to a second embodiment of the present invention is a finely shaped structure which includes a supporting member; a buffer layer; and a pattern layer having a fine asperity pattern formed on a surface thereof, in which the buffer layer is arranged between the supporting member and the pattern layer, the pattern layer is made from a resin through curing of a resin composition containing a cationic-polymerization catalyst and two or more organic components having different functional groups, and the supporting member, the buffer layer and the pattern layer each transmit light having a wavelength of 365 nm or longer.

The supporting member for use in the present invention is not particularly limited on material, size, and preparation process thereof, as long as having the function of holding or supporting the pattern layer. A material for the supporting member can be any of materials having certain strength and workability, such as silicon wafers, various metallic materials, glass, quartz, ceramics and plastics. Specific examples thereof include Si, SiC, SiN, polysilicon (poly-Si), Ni, Cr, Cu, and materials each containing one or more of them. Of these, quartz is preferred because it has high transparency and allows efficient irradiation of the resin with light when the pattern layer and the buffer layer are made from a photocurable material.

The surface of such a supporting member has been preferably subjected to a coupling treatment for increasing adhesion with respect to the pattern layer and the buffer layer.

The pattern layer for use in the present invention is formed by applying a resin composition to be a liquid original plate formed on a surface of the supporting member, the resin composition containing a cationic-polymerization catalyst and two or more organic components having different functional groups; pressing a master mold against the resin composition; and curing the resin composition. The formed asperity geometry therefore ends up with an inverse of the asperity pattern of the master mold. The curing is performed through light irradiation, heating, or a combination of them.

The pattern layer after curing can transmit light having a wavelength of 365 nm or longer, and this allows the fine structure according to the present invention to be used as a photonanoprint replica mold. As used herein, the “glass transition temperature (Tg)” refers to a temperature around which a material in question shows significant changes in elastic modulus and coefficient of linear expansion. The glass transition temperature (Tg) can be determined typically with a visco-elastometer, coefficient of linear expansion evaluation apparatus, or differential scanning calorimeter. The higher the glass transition temperature (Tg) of the pattern layer after curing is, the more preferred in the present invention. Thus, the pattern layer allows a replica mold to have a high pattern accuracy when the replica mold is prepared through electroplating after the formation of an electrode layer through nonelectrolytic plating, when having a glass transition temperature (Tg) of 50° C. or higher.

When the fine structure according to the present invention is used as the nanoimprinting mold, the fine structure may further include a release layer on the surface of the pattern layer, so as to reduce interactions with the object to be transferred. Exemplary materials usable for the release layer include fluorochemical surfactants and silicone surfactants. Exemplary fluorochemical surfactants usable herein include perfluoroalkyl-containing oligomer solutions prepared by dissolving perfluoroalkyl-containing oligomers in solvents. Such fluorochemical surfactants can also be those having a perfluoroalkyl chain to which a hydrocarbon chain is bound; those structurally including a perfluoroalkyl chain to which an ethoxy chain or methoxy chain is bound; and those structurally including such perfluoroalkyl chain to which a siloxane is bound. Besides them, commercially available fluorochemical surfactants are also usable. The release layer may bear the surfactant as covalently bonded to the surface of the pattern layer or as merely sedimented.

The resin composition for constituting the pattern layer for use in the present invention includes a cationic-polymerization catalyst and two or more organic components having different functional groups. The organic components each preferably have at least one functional group selected from the group consisting of epoxy groups, oxetanyl groups and vinyl ether groups. The term “organic components” does not basically include solvent components having no reactive functional group. However, such solvent components having no reactive functional group do not adversely affect the advantageous effects of the present invention, if involuntarily contained in the resin composition. Exemplary organic components having epoxy group(s) for use in the present invention include bisphenol-A epoxy resins, hydrogenated bisphenol-A epoxy resins, bisphenol-F epoxy resins, novolak epoxy resins, alicyclic epoxy resin, naphthalene epoxy resins, biphenyl epoxy resins and bifunctional alcohol ether epoxy resins. Exemplary organic components having oxetanyl group include 3-ethyl-3-hydroxymethyloxetane, 1,4-bis[(3-ethyl-3-oxetanylmethoxy)methyl]benzene, 3-ethyl-3-(phenoxymethyl)oxetane, di[1-ethyl(3-oxetanyl)]methyl ether, 3-ethyl-3-(2-ethylhexyloxymethyl)oxetane, 3-ethyl-3-{[3-(triethoxysilyl)propoxy]methyl}oxetane, oxetanylsilsesquioxane and phenol-novolak oxetanes. Exemplary organic components having vinyl ether group include ethylene glycol divinyl ether, diethylene glycol divinyl ether, triethylene glycol divinyl ether, tetraethylene glycol divinyl ether, butanediol divinyl ether, hexanediol divinyl ether, cyclohexanedimethanol divinyl ether, di (4-vinyloxy)butyl isophthalate, di (4-vinyloxy)butyl glutarate, di (4-vinyloxy)butyl succinate, trimethylolpropane trivinyl ether, 2-hydroxyethyl vinyl ether, hydroxybutyl vinyl ether and hydroxyhexyl vinyl ether. Hereinabove, there have been listed, as examples, organic components each having one type of functional group selected from the group consisting of epoxy groups, oxetanyl groups and vinyl ether groups, but the organic components usable in the present invention are not limited thereto. Any organic components can be basically used in the present invention, as long as having one or more of epoxy groups, oxetanyl groups and vinyl ether groups in molecular chain. One of such organic components to be contained in the resin composition is preferably a multifunctional organic component having two or more functional groups, because such multifunctional organic component helps a cured article of the resin composition to have crosslinking points in a larger number and to thereby have a higher glass transition temperature (Tg).

The cationic-polymerization catalyst for use in the present invention is not especially limited, as long as being an electrophilic reagent, having a cation source, and cures the organic components by the action of heat or light, and can be chosen from known cationic-polymerization catalysts. Among them, cationic-polymerization catalysts which initiate the curing by the action of ultraviolet rays are preferred, because they enable the formation of asperity patterns at room temperature and thereby allow the formation of a replica from a master mold further highly accurately. Exemplary cationic-polymerization catalysts include iron-allene complex compounds, aromatic diazonium salts, aromatic iodonium salts, aromatic sulfonium salts, pyridinium salts, aluminum complex/silyl ether, protonic acids and Lewis acids. Specific examples of cationic-polymerization catalysts which initiate the curing by the action of ultraviolet rays include IRGACURE 261 (supplied by Ciba Geigy, Ltd. (now part of BASF)), OPTOMER SP-150 (supplied by ADEKA CORPORATION), OPTOMER SP-151 (supplied by ADEKA CORPORATION), OPTOMER SP-152 (supplied by ADEKA CORPORATION), OPTOMER SP-170 (supplied by ADEKA CORPORATION), OPTOMER SP-171 (supplied by ADEKA CORPORATION), OPTOMER SP-172 (supplied by ADEKA CORPORATION), UVE-1014 (supplied by General Electronics Co.), CD-1012 (supplied by Sartomer Company Inc.), San-Aid SI-60L (supplied by Sanshin Chemical Industry Co., Ltd.), San-Aid SI-80L (supplied by Sanshin Chemical Industry Co., Ltd.), San-Aid SI-100L (supplied by Sanshin Chemical Industry Co., Ltd.), San-Aid SI-110 (supplied by Sanshin Chemical Industry Co., Ltd.), San-Aid SI-180 (supplied by Sanshin Chemical Industry Co., Ltd.), CI-2064 (supplied by Nippon Soda Co., Ltd.), CI-2639 (supplied by Nippon Soda Co., Ltd.), CI-2624 (supplied by Nippon Soda Co., Ltd.), CI-2481 (supplied by Nippon Soda Co., Ltd.), Uvacure1590 (Daicel UCB (now DAICEL-CYTEC Company Ltd.)), Uvacure1591 (Daicel UCB (now DAICEL-CYTEC Company Ltd.)), RHODORSIL Photoinitiator 2074 (supplied by Rhone-Poulenc), UVI-6990 (supplied by Union Carbide Corporation (now subsidiary of The Dow Chemical Company)), BBI-103 (supplied by Midori Kagaku Co., Ltd.), MPI-103 (supplied by Midori Kagaku Co., Ltd.), TPS-103 (supplied by Midori Kagaku Co., Ltd.), MDS-103 (supplied by Midori Kagaku Co., Ltd.), DTS-103 (supplied by Midori Kagaku Co., Ltd.), DTS-103 (supplied by Midori Kagaku Co., Ltd.), NAT-103 (supplied by Midori Kagaku Co., Ltd.), NDS-103 (supplied by Midori Kagaku Co., Ltd.) and CYRAURE UVI6990 (Union Carbide Japan). Each of such polymerization initiators can be used alone or in combination. They can also be employed in combination typically with any of known polymerization accelerators and sensitizers.

The resin composition for use in the present invention may further contain one or more surfactants for improving adhesive strength with the supporting member and may further contain additives such as polymerization inhibitors, where necessary.

The buffer layer for use in the present invention can be any elastic article that elastically deforms at room temperature. The buffer layer is arranged between the hard or rigid supporting member and the pattern layer. Thus, when foreign particles or bumps are present, the buffer layer elastically deforms together with the pattern layer and whereby has the functions of protecting the fine asperity pattern on the surface of the pattern layer and of minimizing transfer failure regions. In addition, when the substrate to be transferred has undulation on a surface thereof, the buffer layer has the function of allowing the fine asperity pattern on the surface of the pattern layer to conform to or follow the undulation. For this reason, the buffer layer for use in the present invention is preferably formed from a material having an elastic modulus lower than that of the pattern layer and having a thickness larger than that of the pattern layer. When the fine structure is used in a photonanoimprint process, the buffer layer should use a material that transmits light having a wavelength of 365 nm or longer.

A material for the pattern layer is not limited, as long as a material that transmits ultraviolet rays.

Exemplary materials for the buffer layer include polymeric materials including resins such as fluorocarbon rubbers, fluorinated silicone rubbers, acrylic rubbers, hydrogenated nitrile rubbers, ethylene-propylene rubbers, chlorosulfonated polystyrene rubbers, epichlorohydrin rubbers, isobutylene-isoprene rubber, urethane rubbers, polycarbonate (PC)/acrylonitrile-butadiene-styrene (ABS) alloys, polysiloxane dimethylene terephthalate (PCT)/poly(ethylene terephthalate) (PET), copolymerized poly(butylene terephthalate) (PBT)/polycarbonate (PC) alloys, polytetrafluoroethylenes (PTFE), fluorinated ethylene-propylene polymers (FEP), polyarylates, polyamide (PA)/acrylonitrilebutadienestyrene (ABS) alloys, modified epoxy resins and modified polyolefins. Exemplary materials further include resins such as epoxy resins, unsaturated polyester resins, epoxy isocyanate resins, maleimide resins, maleimide epoxy resins, cyanate resins, cyanate epoxy resins, cyanate maleimide resins, phenol resins, diallyl phthalate resins, urethane resins, cyanamide resins and maleimide cyanamide resins; and polymeric resins containing two or more of these resins in combination.

After further intensive investigations, the present inventors have found that the above problems can be solved by using a stamper having a multilayer structure whose constitutive layers differing in Young's modulus.

A stamper for imprinting according to an embodiment of the present invention is a stamper having a fine asperity geometry formed on a surface thereof and is adopted to transferring of the asperity geometry on the surface thereof to a surface of a object to be transferred by bringing the stamper into contact with the object to be transferred. The stamper includes a pattern layer having the asperity geometry; a buffer layer arranged on another surface of the pattern layer opposite to the surface on which the asperity geometry is formed; and a base layer arranged on another surface of the buffer layer opposite to the surface on which the pattern layer is arranged, in which the buffer layer has a Young's modulus lower than the Young's modulus of the pattern layer, and the base layer has a Young's modulus higher than the Young's modulus of the buffer layer.

In the stamper for imprinting according to the present invention, the buffer layer preferably has a thickness larger than the thickness of the pattern layer.

In the stamper for imprinting according to the present invention, the base layer preferably has a thickness larger than the thickness of the pattern layer.

In the stamper for imprinting according to the present invention, the buffer layer preferably has a Young's modulus of 1.5 GPa or less.

In the stamper for imprinting according to the present invention, the buffer layer preferably has a thickness of 4.2 μm or more.

In the stamper for imprinting according to the present invention, the pattern layer preferably has a thickness in the range of 100 nm to 43 μm.

In the stamper for imprinting according to the present invention, the pattern layer preferably is detachable from the buffer layer and exchangeable.

A stamper for imprinting according to another embodiment of the present invention is a stamper on which surface a fine asperity geometry is formed and is configured to be in contact with an object to be transferred to transfer the asperity geometry on the surface of the stamper to a surface of the object to be transferred. The stamper includes a pattern layer having a surface on which the asperity geometry is formed; a buffer layer arranged on another surface of the pattern layer opposite to the surface on which the asperity geometry is formed; a base layer arranged on another surface of the buffer layer opposite to the surface on which the pattern layer is arranged; and at least one intermediate layer between the pattern layer and the buffer layer and/or between the buffer layer and the base layer, in which the buffer layer has a Young's modulus lower than the Young's modulus of the pattern layer, and the base layer has a Young's modulus higher than the Young's modulus of the buffer layer.

In the stamper for imprinting according to another embodiment of the present invention, the buffer layer preferably has a thickness larger than the thickness of the pattern layer.

In the stamper for imprinting according to another embodiment of the present invention, the base layer preferably has a thickness larger than the thickness of the pattern layer.

In the stamper for imprinting according to another embodiment of the present invention, the intermediate layer preferably has a Young's modulus lower than the Young's modulus of the pattern layer.

In the stamper for imprinting according to another embodiment of the present invention, the intermediate layer preferably has a thickness smaller than the thickness of the buffer layer.

In the stamper for imprinting according to another embodiment of the present invention, the buffer layer preferably has a Young's modulus of 1.5 GPa or less.

In the stamper for imprinting according to another embodiment of the present invention, the buffer layer preferably has a thickness of 4.2 μm or more.

In the stamper for imprinting according to another embodiment of the present invention, the pattern layer preferably has a thickness in the range of 100 nm to 43 μm.

The stamper for imprinting according to another embodiment of the present invention may include an exchangeable unit composed of at least one layer including the pattern layer; and a reusable unit arranged on another surface of the exchangeable unit opposite to the surface on which the asperity geometry is formed, in which the exchangeable unit is detachable from the reusable unit and is exchangeable.

The stamper for imprinting according to another embodiment of the present invention may include the exchangeable unit, the reusable unit, and an adhesive layer between the exchangeable unit and the reusable unit, in which the adhesive layer loses its adhesiveness upon the application of heat or light.

In the stamper for imprinting according to another embodiment of the present invention, the exchangeable unit and the reusable unit may be in intimate contact and fixed with each other.

A method for imprinting according to an embodiment of the present invention uses the stamper which includes an exchangeable unit having a surface on which the asperity geometry is formed; and a reusable unit arranged on another surface of the exchangeable unit opposite to the asperity geometry. The method includes the steps of contacting the stamper with the object to be transferred; transferring the asperity geometry to the object to be transferred by pressing the stamper against the object to be transferred; detaching the exchangeable unit from the reusable unit; releasing the object to be transferred from the exchangeable unit; and bringing another exchangeable unit into intimate contact with the reusable unit.

In the method for imprinting according to the present invention, the exchangeable unit of the stamper may include the pattern layer and the intermediate layer; and the reusable unit includes the buffer layer and the base layer.

The present invention will be illustrated in further detail with reference to several working examples below. It should be noted, however, that these examples are never construed to limit the scope of the present invention. All “parts” and “percentages” hereinbelow are by weight, unless otherwise specified.

### Example 1

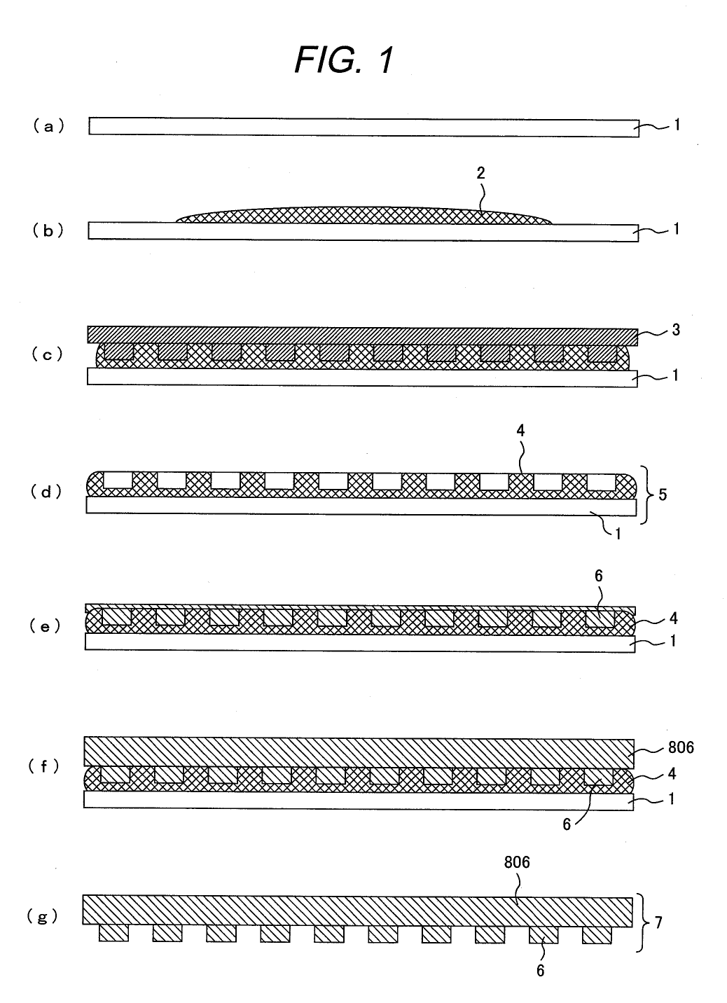

FIG. 1 depicts schematic cross-sectional views illustrating a method for producing a fine structure according to the present invention. Hereinafter a fine structure according to an embodiment of the present invention and a method for replicating a nickel replica mold will be described.

Initially, a resin composition for pattern layer was prepared by blending 10 parts of OXT221 (supplied by Toagosei Co., Ltd.) as an organic component having oxetanyl groups, 10 parts of a bisphenol-AD epoxy resin EPOMIK R710 (supplied by Mitsui Chemicals Inc.) as an organic component having epoxy groups, and 0.6 part of ADEKA OPTOMER SP-152 (supplied by ADEKA CORPORATION) as a cationic-polymerization catalyst.

Next, a supporting member 1 having a size of 50-mm square and a thickness of 3 mm (50 mm×50 mm×3 mm) and made of quartz was prepared after treating a surface thereof with a coupling agent KBM603 (supplied by Shin-Etsu Silicones (a division of Shin-Etsu Chemical Co., Ltd.)) (FIG. 1 (a)). Next, the resin composition 2 for pattern layer was added dropwise onto the surface of the supporting member 1 which surface had been treated with the coupling agent (FIG. 1 (b)). Next, while being pressed by a master mold 3 made of quartz, the resin composition 2 was irradiated with an ultraviolet ray having a wavelength of 365 nm for 500 seconds (FIG. 1 (c)). The master mold 3 had a line pattern having a width of 200 nm, a pitch of 400 nm, and a height of 200 nm formed on a surface thereof, which surface bearing the pattern had been treated with a release agent OPTOOL DSX (supplied by Daikin Industries Ltd.). Next, the master mold 3 was released from the cured resin composition to form a pattern layer 4. Thus, a fine structure 5 according to the present invention was prepared (FIG. 1 (d)).

Next, an electroless nickel coating 6 having a thickness of 300 nm was formed on the surface of the fine structure through nonelectrolytic plating at a plating bath temperature of 50° C. (FIG. 1 (e)). Next, a nickel layer 806 having a thickness of 100 μm was formed through electro-nickel plating (FIG. 1 (f)). The plated nickel sheet composed of the electroless nickel coating 6 and the nickel layer 806 was released from the fine structure 5 to give a nickel replica mold 7 (FIG. 1 (g)).

The pattern shape of the prepared nickel replica mold 7 was measured with an atomic force microscope (supplied by Veeco Instruments Inc.) and evaluated on error with respect to the shape of the master mold 3. The glass transition temperature (Tg) of the pattern layer 4 was determined through differential scanning calorimetry (DSC). The results are shown in Table 1. The pattern layer 4 was found to have a glass transition temperature (Tg) of 50° C., and the resulting nickel replica mold 7 (nickel replica) was found to have a high accuracy in terms of dimensional error in the height direction of 1% or less.

### Example 2

Initially, a resin composition for pattern layer was prepared by blending 10 parts of OXT101 (supplied by Toagosei Co., Ltd.) as an organic component having oxetanyl groups, 10 parts of a multifunctional epoxy resin EHPE 3150CE (Daicel Chemical Industries, Ltd.) as an organic component having epoxy groups, and 0.6 part of ADEKA OPTOMER SP-152 (supplied by ADEKA CORPORATION) as a cationic-polymerization catalyst. Except for using this resin composition, a nickel replica was formed by the procedure of Example 1.

The glass transition temperature (Tg) of the pattern layer was determined through DSC. The results are shown in Table 1. The pattern layer was found to have a glass transition temperature (Tg) of 50° C., and the resulting nickel replica was found to have a high accuracy in terms of a dimensional error in the height direction of 1% or less.

### Example 3

Initially, a resin composition for pattern layer was prepared by blending 10 parts of OXT221 (supplied by Toagosei Co., Ltd.) as an organic component having oxetanyl groups, 10 parts of a multifunctional epoxy resin EHPE 3150CE (Daicel Chemical Industries, Ltd.) as an organic component having epoxy groups, and 0.6 part of ADEKA OPTOMER SP-152 (supplied by ADEKA CORPORATION) as a cationic-polymerization catalyst. Except for using this resin composition, a nickel replica was formed by the procedure of Example 1.

The glass transition temperature (Tg) of the pattern layer was determined through DSC. The results are shown in Table 1. The pattern layer was found to have a glass transition temperature (Tg) of 50° C., and the resulting nickel replica was found to have a high accuracy in terms of dimensional error in the height direction of 1% or less.

### Example 4

Initially, a resin composition for pattern layer was prepared by blending 10 parts of RAPI-CURE DPE-3 (supplied by ISP Japan Ltd.) as an organic component having vinyl ether groups, 1 part of FANCRYL FA-513M (supplied by Hitachi Chemical Co., Ltd.) as an organic component having dicyclopentenyl groups, and 0.6 part of ADEKA OPTOMER SP-152 (supplied by ADEKA CORPORATION) as a cationic-polymerization catalyst. Except for using this resin composition, a nickel replica was formed by the procedure of Example 1.

The glass transition temperature (Tg) of the pattern layer was determined through DSC. The results are shown in Table 1. The pattern layer was found to have a glass transition temperature (Tg) of 50° C., and the resulting nickel replica was found to have a high accuracy in terms of dimensional error in the height direction of 1% or less.

### Example 5

A method for producing a fine structure according to an embodiment of the present invention will be illustrated below.

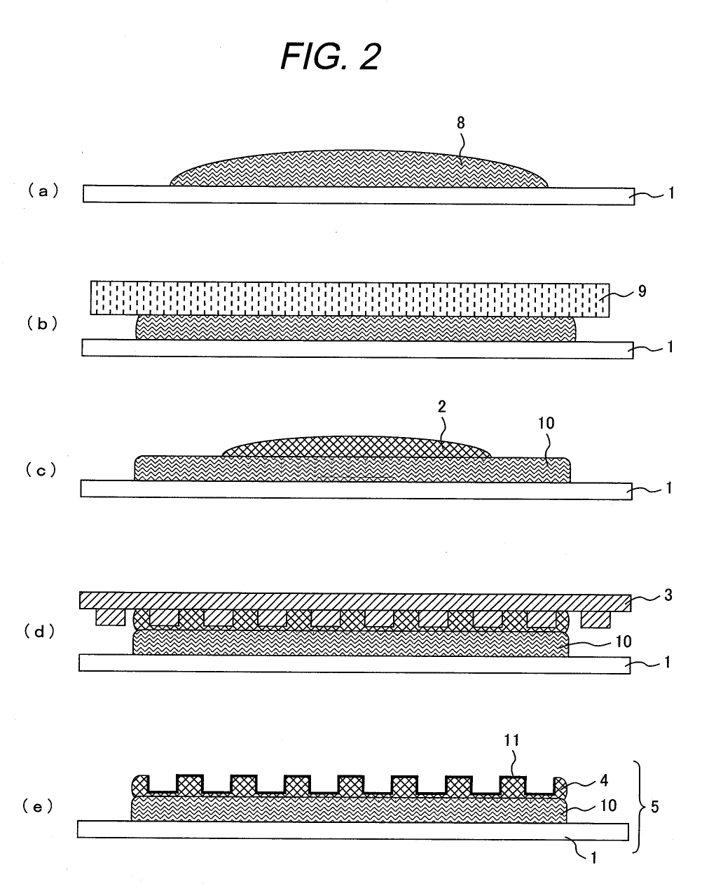

FIG. 2 depicts schematic cross-sectional views illustrating the method for producing a fine structure according to the present invention.

Initially, a resin composition for pattern layer was prepared by blending 10 parts of OXT221 (supplied by Toagosei Co., Ltd.) as an organic component having oxetanyl groups, 10 parts of a bisphenol-AD epoxy resin EPOMIK R710 (supplied by Mitsui Chemicals Inc.) as an organic component having epoxy groups, and 0.6 part of ADEKA OPTOMER SP-152 (supplied by ADEKA CORPORATION) as a cationic-polymerization catalyst. Independently, a material composition for buffer layer was prepared by blending 100 parts of a urethane acrylate oligomer UV3500BA (supplied by Nippon Synthetic Chemical Industry Co., Ltd.), 10 parts of a glycidyl methacrylate Light-Erter G (supplied by Kyoeisha Chemical Co., Ltd.), and 5 parts of a photoinitiator Darocure 1173 (supplied by Ciba Specialty Chemicals).

Next, a supporting member 1 having a size of 50-mm square and a thickness of 3 mm (50 mm×50 mm×3 mm) and made of quartz was prepared after treating a surface thereof with a coupling agent KBM 5103 (supplied by Shin-Etsu Silicones (a division of Shin-Etsu Chemical Co., Ltd.)), and the material composition 8 for buffer layer was applied to a surface of the supporting member 1 (FIG. 2 (a)). The material composition 8 for buffer layer was irradiated with an ultraviolet ray having a wavelength of 365 nm for 200 seconds while being pressed by a flat plate 9 and planarized, in which the flat plate 9 had been treated with Optool DSX (FIG. 2 (b)). The buffer layer had a glass transition temperature (Tg) of room temperature or lower and had an elastic modulus at room temperature lower than that of the pattern layer. Next, the flat plate 9 was released from the cured buffer layer 10, and the resin composition 2 for pattern layer was added dropwise onto the buffer layer 10 (FIG. 2 (c)). Next, while being pressed by a master mold 3 made of quartz, the resin composition 2 was irradiated with an ultraviolet ray having a wavelength of 365 nm for 500 seconds (FIG. 2 (d)). The master mold 3 had a line pattern having a width of 200 nm, a pitch of 400 nm, and a height of 200 nm formed on a surface thereof, which surface bearing the pattern had been treated with a release agent OPTOOL DSX (supplied by Daikin Industries Ltd.). Next, the master mold 3 was released from the cured resin composition to give a pattern layer 4. Thus, the fine structure 5 according to the present invention was prepared (FIG. 2 (e)). The patterned surface (as convexities and concavities) of the pattern layer 4 was subjected to an oxygen plasma treatment and thereafter subjected to a treatment with a release agent OPTOOL DSX (supplied by Daikin Industries Ltd.) to form a release layer 11.

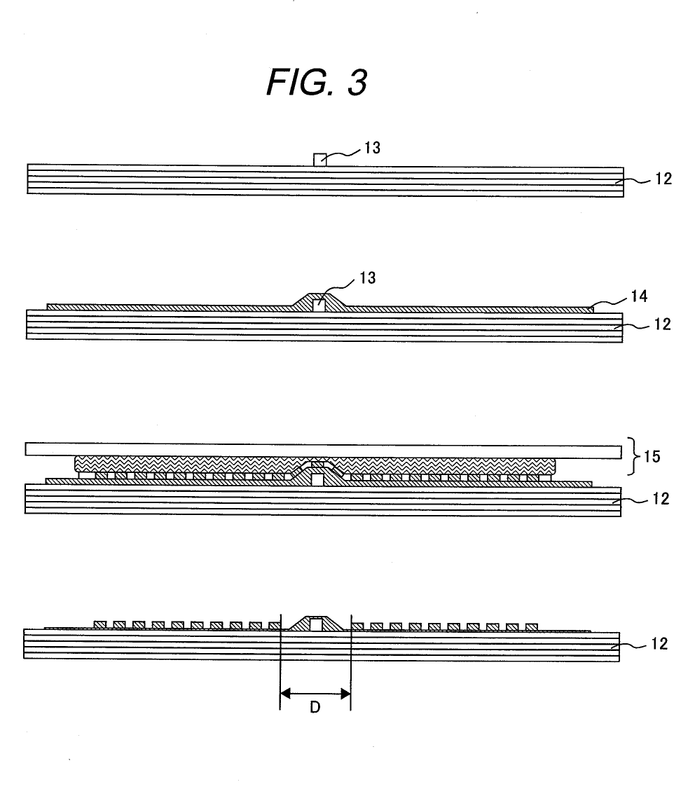

FIG. 3 depicts schematic cross-sectional views illustrating a pattern transfer step using the fine structure according to the present invention.

A pattern transfer was performed by applying a photocurable resin 14 (photonanoimprinting resin PAK-01 (supplied by Toyo Gosei Co., Ltd.)) to a substrate to be transferred 12, on which a simulated bump 13 having a diameter 1 μm and a height of 1 μm had been formed; pressing the fine structure produced according to this example as a resinous replica stamper 15 against the applied photocurable resin 14 at a pressure of 1 MPa; applying an ultraviolet ray having a wavelength of 365 nm for 500 seconds; and releasing the resinous replica stamper. Thereafter, a pattern failure region D on the substrate to be transferred 12 was measured, and whether the resinous replica stamper 15 was broken or not was observed. The results are shown in Table 1.

In this example, it was found that the pattern failure region D had a diameter of 100 μm or less and the resinous replica stamper 15 showed no breakage on the pattern surface.

### Example 6

A resinous replica stamper was prepared by the procedure of Example 5, except for forming a buffer layer using EG6301 (supplied by Dow Corning Toray Co., Ltd.) as the material composition for buffer layer through potting, followed by thermal curing at 150° C. for 1 hour. The resulting buffer layer had a glass transition temperature (Tg) of room temperature or lower and had an elastic modulus at room temperature lower than that of the pattern layer. In addition, the buffer layer was subjected to a surface treatment with Primer D3 (supplied by Dow Corning Toray Co., Ltd.) for imparting adhesiveness to the surface.

Next, a pattern transfer was performed, a pattern failure region D on the substrate to be transferred was measured, and whether the resinous replica stamper was broken or not was observed each by the procedure of Example 5. The results are shown in Table 1. It was found that the pattern failure region D had a diameter of 100 μm or less and the resinous replica stamper showed no breakage on the pattern surface.

### Example 7

A resinous replica stamper was prepared by the procedure of Example 5, except for using the resin composition prepared in Example 2 as the resin composition for pattern layer.

Next, a pattern transfer was performed, a pattern failure region D on the substrate to be transferred was measured, and whether the resinous replica stamper was broken or not was observed each by the procedure of Example 5. The results are shown in Table 1. It was found that the pattern failure region D had a diameter of 100 μm or less and the resinous replica stamper showed no breakage on the pattern surface.

### Example 8

A resinous replica stamper was prepared by the procedure of Example 5, except for using the resin composition prepared in Example 3 as the resin composition for pattern layer.

Next, a pattern transfer was performed, a pattern failure region D on the substrate to be transferred was measured, and whether the resinous replica stamper was broken or not was observed each by the procedure of Example 5. The results are shown in Table 1. It was found that the pattern failure region D had a diameter of 100 μm or less and the resinous replica stamper showed no breakage on the pattern surface.

### Comparative Example 1

A fine structure was formed, and a nickel replica stamper was prepared by the procedure of Example 1 using this fine structure, except for using a free-radically polymerizable acrylate resin as the resin composition for pattern layer.

The glass transition temperature (Tg) of the pattern layer was determined through DSC. The results are shown in Table 1. The pattern layer was found to a glass transition temperature (Tg) of 40° C. and the resulting nickel replica was found to have a dimensional error in the height direction of 5.

### Comparative Example 2

A fine structure was formed, and, using this, a nickel replica stamper was prepared by the procedure of Example 1, except for preparing a resin composition for pattern layer by blending 10 parts of a bisphenol-AD epoxy resin EPOMIK R710 (supplied by Mitsui Chemicals Inc.) as an organic component having epoxy groups alone and 0.6 part of ADEKA OPTOMER SP-152 (supplied by ADEKA CORPORATION) as a cationic-polymerization catalyst.

The glass transition temperature (Tg) of the pattern layer was determined through DSC. The results are shown in Table 1. The pattern layer was found to have a glass transition temperature (Tg) of 50° C. or higher, but the resulting nickel replica had a dimensional error in the height direction of 10% or more.

### Comparative Example 3

A pattern transfer was performed under conditions as in Example 5, except for using a quartz mold on which fine convexities and concavities as in Example 5 had been formed. As a result, the pattern surface of the quartz mold suffered from breakage in the vicinity of the simulated bump and suffered from a transfer failure region D extending over several millimeters.

TABLE 1

| | Example 1 | Example 2 | Example 3 | Example 4 | Example 5 | Example 6 |
|---|---|---|---|---|---|---|
| Pattern accuracy | 1% or | 1% or | 1% or | 1% or | 1% or | 1% or |
| Examples 1 to 4: | less | less | less | less | less | less |
| Master mold/Ni replica | | | | | | |
| Examples 5 to 8: | | | | | | |
| Master mold/pattern | | | | | | |
| layer | | | | | | |
| Pattern layer Tg | 50° C. or | 50° C. or | 50° C. or | 50° C. or | 50° C. or | 50° C. or |
| | higher | higher | higher | higher | higher | higher |
| Mold breakage | — | — | — | — | absent | absent |
| Transfer failure region size | — | — | — | — | 0.1 mm or | 0.1 mm or |
| | | | | | less | less |

| | Example 7 | Example 8 | Com. Ex. 1 | Com. Ex. 2 | Com. Ex. 3 |
|---|---|---|---|---|---|
| Pattern accuracy | 1% or | 1% or | 5% | 10% | — |
| Examples 1 to 4: | less | less | | | |
| Master mold/Ni replica | | | | | |
| Examples 5 to 8: | | | | | |
| Master mold/pattern | | | | | |
| layer | | | | | |
| Pattern layer Tg | 50° C. or | 50° C. or | 40° C. | 50° C. or | — |
| | higher | higher | | higher | |
| Mold breakage | absent | absent | — | — | present |
| Transfer failure region size | 0.1 mm or | 0.1 mm or | — | — | 1 mm or |
| | less | less | | | more |

Embodiments of the stamper for imprinting according to the present invention will be illustrated with reference to the attached drawings according to necessity.

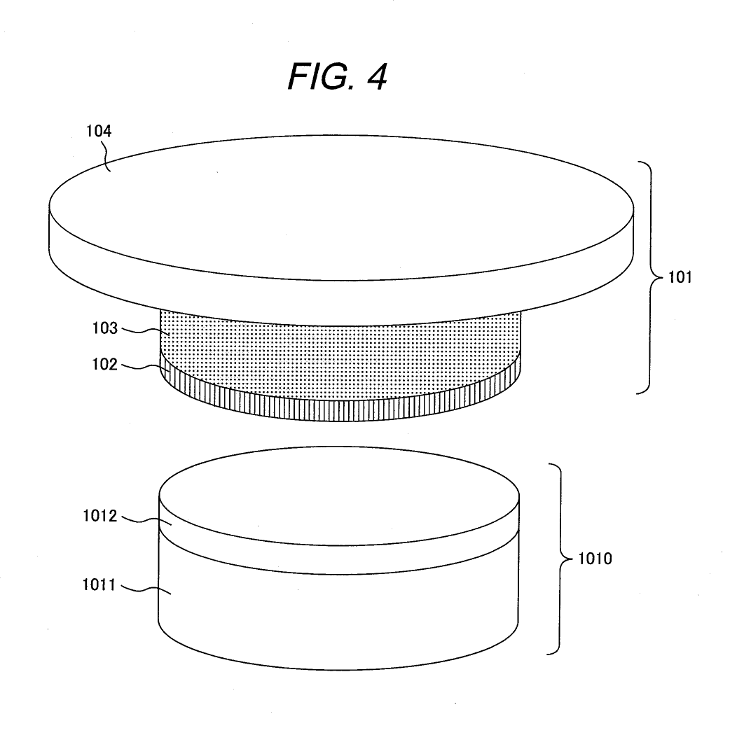

FIG. 4 is a schematic diagram of structures of a stamper according to an embodiment of the present invention and of an object to be transferred.

With reference to FIG. 4, the stamper 101 includes a base layer 104, and below a surface thereof, a buffer layer 103 and a pattern layer 102 arranged in this order. When a pattern transfer is performed, the object to be transferred 1010 including a substrate to be transferred 1011 and, applied thereon, a resin to be transferred 1012 is arranged so that the resin to be transferred 1012 faces the pattern layer 102 of the stamper 101. The pattern layer 102 has a fine asperity pattern formed on a surface thereof facing the resin to be transferred 1012. The stamper 101 may have any of circular, elliptical, and polygonal outside shapes. The stamper 101 may also have a hole opened at the center thereof. In the stamper 101 having this structure, the Young's moduli of materials constituting the respective layers and the thicknesses of the respective layers affect the bump conformity of the stamper.

The term “bump conformity” as used herein is defined as follows.

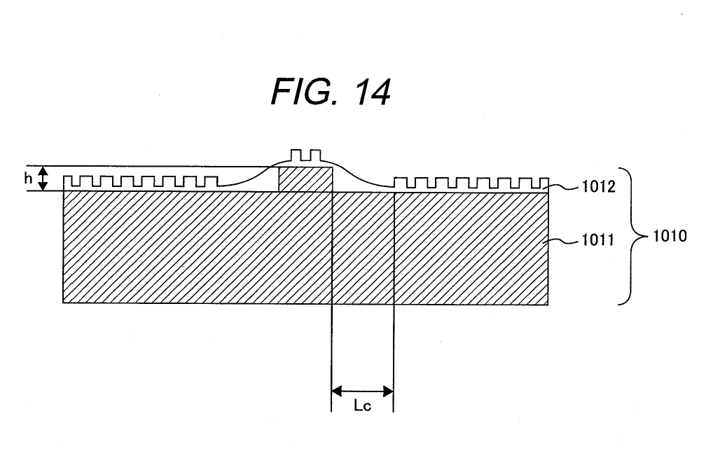

As is described above, a stamper does not completely conform to around a bump locally present on a substrate to be transferred to thereby cause a transfer failure region where an intended asperity pattern is not formed. The “bump conformity” herein is defined as an index showing how the stamper conform to a bump having a certain height and is indicated as Lc/h, wherein Lc represented by the distance from the edge of the bump to the outer periphery of the transfer failure region; and h represents the height of the bump, as demonstrated in FIG. 14.

The base layer 104 as illustrated in FIG. 4 is enough to be composed of a material which is harder than the buffer layer 103 mentioned below and has a Young's modulus higher than that of the buffer layer. This is in order to control the pressure for the stamper 101 to conform to bumps and allow the stamper 101 to be satisfactorily adopted to operations, such as alignment and conveyance, in an imprinting process. Exemplary shapes of the stamper 101 and exemplary materials for the base layer 104 include processed materials derived typically from materials such as silicones, glass, aluminum and resins. The base layer 104 may have a multilayers structure, in which one or more other layers such as a metallic layer, resinous layer, and oxide film layer are formed on a surface thereof.

A stamper 101 is in danger of causing decrease in pattern accuracy and alignment accuracy because such stamper 101 is difficult to hold its shape and deforms, if including a pattern layer 102 and a buffer layer 103 alone. In contrast, the presence of the base layer 104 suppresses the deformation of the stamper 101 to thereby improve pattern accuracy and alignment accuracy.

The buffer layer 103 is an elastic layer formed on a surface of the base layer 104 and is composed of a material which has a Young's modulus lower than those of a material constituting the base layer 104 and a material constituting the after-mentioned pattern layer 102 and which elastically deforms at room temperature. The buffer layer 103 having such a Young's modulus promotes the stamper 101 to geometrically vary to thereby fit bumps.

When the resin to be transferred 1012 applied to the substrate to be transferred 1011 is photocurable, the stamper 101 according to the present invention is selected from those having transparency, because electromagnetic waves such as ultraviolet rays should be applied through the stamper 101. For this reason, the material for the buffer layer 103 preferably has transparency. The material, however, may be opaque (impermeable) one when the resin to be transferred 1012 is another material such as a thermally curable resin or thermoplastic resin instead of such a photocurable resin. Exemplary materials for the buffer layer 103 are materials satisfying the above conditions and include phenol resins (PF), urea resins (UF), melamine resins (MF), poly(ethylene terephthalate)s (PET), unsaturated polyester resins (UP), alkyd resins, vinyl ester resins, epoxy resins (EP), polyimide resins (PI), polyurethanes (PUR), polycarbonates (PC), polystyrenes (PS), acrylic resins (e.g., PMMA), polyamide resins (PA), ABS resins, AS resins, AAS resins, poly(vinyl alcohol)s, polyethylenes (PE), polypropylenes (PP), polytetrafluoroethylenes (PTFE), polyarylate resins, cellulose acetate, polypropylenes, poly(ethylene naphthalate)s (PEN), poly(butylene terephthalate)s (PBT), poly(phenylene sulfide)s (PPS), poly(phenylene oxide)s, cycloolefin polymers, poly(lactic acid)s, silicone resins and diallyl phthalate resins. The buffer layer 103 may contain each of different materials alone or in combination. The buffer layer 103 may further contain fillers such as inorganic fillers and organic fillers.

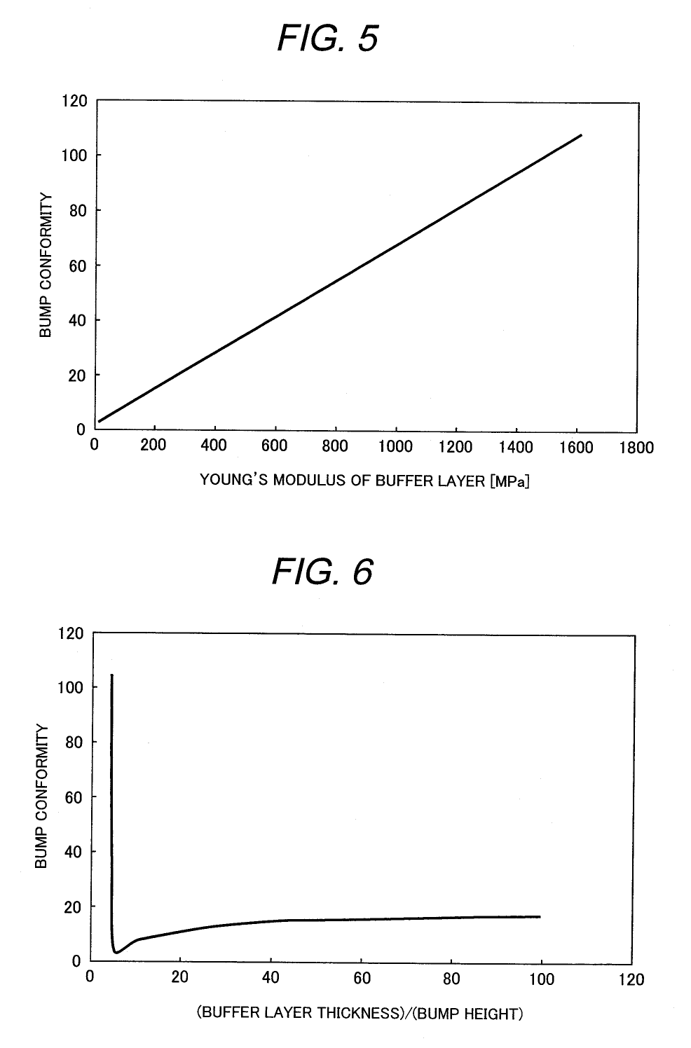

FIG. 5 illustrates how the bump conformity varies at different Young's moduli of the buffer layer 103. Conditions of the respective layers in this experiment are as follows. The buffer layer 103 had a thickness of 1 mm, the pattern layer had a thickness of 0.1 μm, the pattern layer was formed from a photocurable unsaturated polyester resin having a Young's modulus of 2.4 GPa, and the base layer was formed from a quartz glass having a thickness of 1 mm, and a Young's modulus of 72 GPa. Upon transferring, a pressure of 1 MPa was applied from above the base layer 104. FIG. 5 demonstrates that the bump conformity becomes better with a decreasing Young's modulus of the buffer layer. The bump conformity is proportional to the transfer failure region (size), and the bump conformity Lc/h should be 100 or less in order to control the transfer failure region within about 10%. Therefore, the buffer layer 103 should have a Young's modulus of 1.5 GPa or less under the above-mentioned conditions. It should be noted, however, that the bump conformity varies depending typically on the Young's moduli and thicknesses of the respective layers and on the pressurization conditions, and such factors should be designed as appropriate.

FIG. 6 illustrates how the bump conformity varies at different thicknesses of the buffer layer 103. Conditions of the respective layers in this experiment are as follows. The pattern layer 102 had a thickness of 0.1 μm, the buffer layer 103 was formed from an acrylic resin having a Young's modulus of 100 MPa, the pattern layer 102 was formed from a photocurable unsaturated polyester resin having a Young's modulus of 2.4 GPa, and the base layer 104 was formed from a quartz glass having a thickness of 1 mm, and a Young's modulus of 72 GPa. Upon transferring, a pressure of 1 MPa was applied from above the base layer 104. FIG. 6 demonstrates that the bump conformity becomes better with a decreasing thickness of the buffer layer 103, but there is a minimum value, and the bump conformity becomes worse contrarily at excessively small thicknesses of the buffer layer 103. Accordingly, the buffer layer 103 should have a thickness of 4.2 μm or more in order to allow the bump conformity Lc/h to be 100 or less under the above-mentioned conditions. It should be noted, however, that the bump conformity also in this case varies depending typically on the Young's moduli and thicknesses of the respective layers and on the pressurization conditions, and such factors should be designed as appropriate.

The pattern layer 102 is a layer having a fine pattern to be transferred to the object to be transferred 1010 as described above and is composed of such a material that the asperity geometry formed on a surface thereof does not undergo plastic deformation due to the pressure applied during transferring. Exemplary materials for the formation of the pattern layer 102 should be materials satisfying the above conditions and include phenol resins (PF), urea resins (UF), melamine resins (MF), poly(ethylene terephthalate)s (PET), unsaturated polyester resins (UP), alkyd resins, vinyl ester resins, epoxy resins (EP), polyimide resins (PI), polyurethanes (PUR), polycarbonates (PC), polystyrenes (PS), acrylic resins (e.g., PMMA), polyamide resins (PA), ABS resins, AS resins, AAS resins, poly(vinyl alcohol)s, polyethylenes (PE), polypropylenes (PP), polytetrafluoroethylenes (PTFE), polyarylate resins, cellulose acetate, polypropylenes, poly(ethylene naphthalate)s (PEN), poly(butylene terephthalate)s (PBT), poly(phenylene sulfide)s (PPS), poly(phenylene oxide)s, cycloolefin polymers, poly(lactic acid)s, silicone resins and diallyl phthalate resins. The pattern layer 102 may use each of different materials alone or in combination. The pattern layer 102 may further contain fillers such as inorganic fillers and organic fillers. To accelerate the release (separation) between the resin to be transferred 1012 and the stamper 101, the surface (pattern-formed layer) of the pattern layer 102 may be subjected to a treatment typically with a release agent such as a fluorocarbon or silicone release agent. Alternatively, a thin film typically of a metallic compound may be formed as a release layer on the surface of the pattern layer 102.

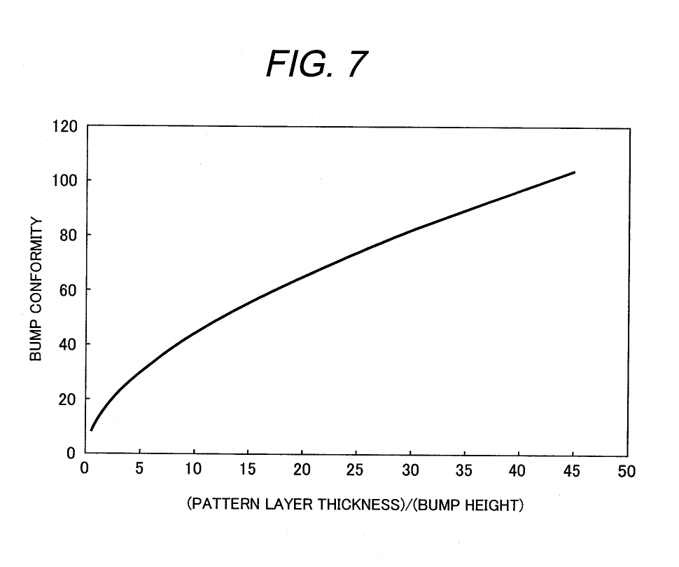

The pattern layer 102 preferably has a thickness within such a range that the stamper has satisfactory resistance to pressure applied during transferring while showing satisfactory bump conformity. FIG. 7 shows how the bump conformity varies at different thicknesses of the pattern layer 102. Conditions of the respective layers herein are as follows. The buffer layer 103 had a thickness of 100 μm, the buffer layer 103 was formed from an acrylic resin having a Young's modulus of 10 MPa, the pattern layer 102 was formed from a photocurable unsaturated polyester resin having a Young's modulus of 2.4 GPa, and the base layer 104 was formed from a quartz glass having a thickness of 1 mm, and a Young's modulus of 72 GPa. Upon transferring, a pressure of 1 MPa was applied from above the base layer 104. FIG. 7 demonstrates that the bump conformity becomes better with a decreasing thickness of the pattern layer 102. The pattern layer 102 preferably has a thickness within the range of 100 nm to 43 μm, in order to allow the bump conformity Lc/h to be 100 or less under the above-mentioned conditions. If the pattern layer 102 has a thickness of less than 100 nm, the resistance to pressure applied during transferring may decrease, and this may cause transferring failure. If the pattern layer 102 has a thickness of more than 43 μm, the bump conformity may decrease, and an untransferred region becomes large. For these reasons, the pattern layer 102 should have a thickness within the range of 100 nm to 43 μm. It should be noted, however, that the bump conformity also in this case varies depending typically on the Young's moduli and thicknesses of the respective layers and on the pressurization conditions, and such factors should be designed as appropriate.

The resulting object to be transferred to which the fine pattern has been transferred is applicable to information recording media such as magnetic recording media and optical recording media. The object to be transferred is also applicable to components of large-scale integrated circuits; optical components such as lenses, sheet polarizers, wavelength filters, light-emitting diodes and integrated optics; and biodevices such as in immuno assays, DNA separation, and cell cultures.

The stamper according to the present invention has such a patterned surface capable of conforming local bumps of the substrate to be transferred, thereby is resistant to breakage, and can significantly reduce transfer failure regions. This stamper has a multilayer structure including a base layer, a buffer layer and a pattern layer, in which the base layer is suitable for controlling the pressure so as to conform to the local bumps and for alignment and conveyance in an imprinting process; the buffer layer has a Young's modulus lower than that of the base layer and thereby allows the stamper to alter its shape; and the pattern layer is composed of such a material that can conform to bumps, does not plastically deform even under the pressure applied during transferring, and is resistant to deformation of the asperity geometry of the stamper even under the pressure applied during transferring.

The stampers for imprinting according to embodiments of the present invention will be illustrated in detail with reference to several working examples below.

### Example 9

Initially, the structure and preparation method thereof of a stamper with three-layer structure used in this example will be explained.

FIG. 4 is a schematic diagram illustrating the structures of the stamper according to the present invention and of a resin to be transferred.

A base layer 104 used herein was a quartz glass having a diameter of 100 mm and a thickness of 1 mm. The quartz glass had a Young's modulus of 72 GPa. A silicone resin die having a thickness of 1 mm and bearing an opened hole 80 mm in diameter was placed on a surface of the base layer 104, and an acrylic photocurable resin for buffer layer 103 was poured into the hole by casting, followed by curing of the poured resin through irradiation with an ultraviolet ray to form a buffer layer 103. The acrylic photocurable resin used for the buffer layer 103 had a Young's modulus after ultraviolet curing of 10 MPa.

Next, a photocurable unsaturated polyester resin for pattern layer 102 was dispensed and dropped to the surface of the buffer layer 103; a silicon master mold was placed thereon; and an ultraviolet ray was applied from the base layer 104 side while pressurizing to form a pattern layer 102 having a thickness of 0.1 μm. The master mold had a trench or groove pattern having a width of 50 nm, a depth of 80 nm, and a pitch of 100 nm. The photocurable unsaturated polyester resin used for the pattern layer 102 had a Young's modulus after ultraviolet curing of 2.4 GPa. The pattern layer 102 was thereafter released from the master mold to give a stamper 101 having a three-layered structure including the pattern layer 102, the buffer layer 103 and the base layer 104.

The stamper 101 according to this embodiment has a round outside shape, but the outside shape is not limited to this in the present invention. The stamper 101 may have any of round (circular), elliptic and polygonal outside shapes according to the pressurizing procedure. Such a stamper 101 may have a hole opened at the center thereof. The stamper 101 may differ from the object to be transferred 1010 in shape (dimensions) and surface area, as long as the stamper 101 can transfer a fine pattern to a predetermined region of the object to be transferred 1010.

Next, a transfer process using the stamper according to this embodiment will be illustrated.

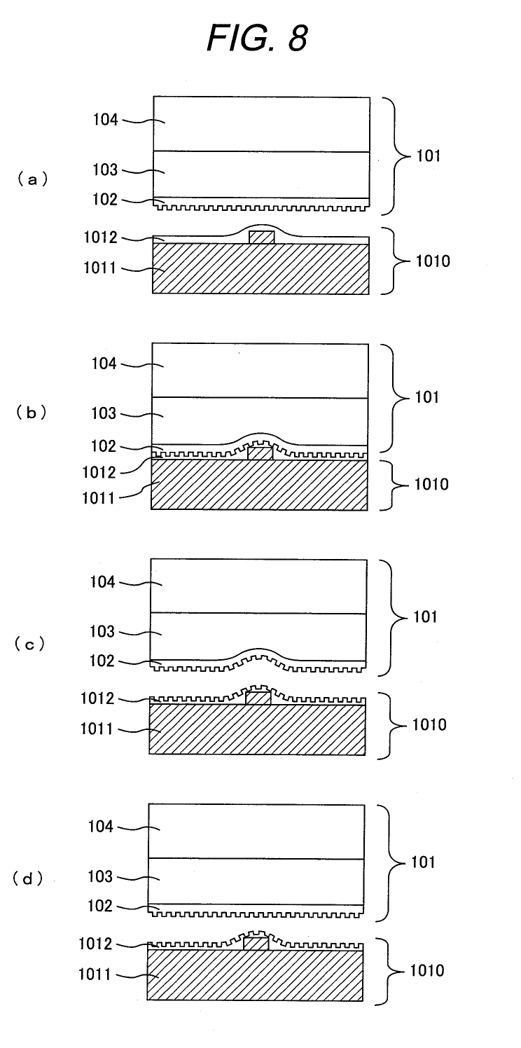

FIG. 8 depicts cross-sectional views of the stamper according to the present invention and of an object to be transferred and illustrates the transfer process.

FIG. 8 (a) shows the shapes of the stamper 101 and a resin to be transferred 1012, respectively, before being contacted with each other for transfer. The stamper 101 in this state includes a pattern layer 102, a buffer layer 103 bonded to the backside of the pattern layer 102, and a base layer 104 bonded to the backside of the buffer layer 103. The stamper 101 as a whole is flat. The object to be transferred 1010 used herein includes a silicon substrate to be transferred 1011 having a length of 20 mm, a width of 20 mm, and a thickness of 1 mm; and applied on a surface thereof, a photocurable resin to be transferred 1012. Upon pattern transfer, the stamper 101 and the substrate to be transferred 1011 are arranged so that the pattern-formed surface of the pattern layer 102 faces the resin to be transferred 1012. The resin 1012 has a bump at the center part thereof. The bump simulates a protruded geometry of the substrate to be transferred 1011 and has a height of 10 μm. The bump will be in contact with the stamper 101 precedently to the other regions on the surface of the resin.

FIG. 8 (b) shows how transfer proceeds while the stamper 101 is brought into contact with the resin to be transferred 1012, and a pressure is applied between the stamper and the resin to allow the stamper 101 to deform along with the bump of the resin. In this example, a pressure of 1 MPa was applied from another surface of the base layer 104 opposite to the pattern layer. The stamper 101 conforms to the bump of the resin by the action of the buffer layer 103 having a Young's modulus lower than that of the pattern layer 102. In this stage, the base layer 104 having a higher Young's modulus helps a larger pressure to be applied to the periphery of the bump and thereby helps the buffer layer 103 to conform to the bump more satisfactorily. The pattern layer 102 is composed of a resin having a higher Young's modulus, and the fine pattern formed on the surface of the pattern layer 102 does not plastically deform but elastically deforms under the pressure applied for transfer. This allows the fine pattern of the stamper 101 to be transferred to the resin surface including even the bump portion, allows an inverse pattern thereof to be formed even on the bump portion, and avoids the breakage of the fine pattern after transfer.

FIG. 8 (c) shows how the resin to be transferred 1012 and the stamper 101 are released from each other after the completion of the pattern transfer. A pattern with inverse of the pattern of the stamper 101 is transferred to the surface of the resin to be transferred 1012, and even the bump portion at the center thereof is patterned, although with some turbulence in pattern shape. A stamper being less deformable causes an untransferred region, if used, because the pattern of the stamper does not reach the periphery of the bump. In contrast, a stamper being more deformable as above, if used, can minimize such an untransferred region.

FIG. 8 (d) shows how the stamper 101 returns from deformation in accordance with the bump to being flat with elapse of time after it has been released from the resin to be transferred 1012. The resin to be transferred 1012 herein maintained the formed fine pattern, and the stamper did not break.

The use of the stamper produced as above allows transfer of an entire resin pattern for the formation of complicatedly-shaped trenches or structure to a resin to be transferred even on a substrate having bumps. This is achieved by contacting the stamper with a resin film formed on a surface of the substrate to be transferred and transferring the asperity pattern on the surface of the stamper to the resin film.

Next, using the stamper according to this embodiment, a fine pattern was transferred to a resin layer having a bump, and the bump conformity was determined. The results are shown below.

A substrate having a bump with a height h of 10 μm was used in this example. The distance Lc from the edge of the bump to the outer periphery of a transfer failure region was measured, this was divided by the height h to give an Lc/h, and the Lc/h was evaluated as the bump conformity. In this example, the Lc/h was found to be 2.7. The stamper did not show breakage after transfer.

### Example 10

A three-layered stamper according to another embodiment having the following configuration was produced by the following method, and the bump conformity of the stamper was determined by the procedure of Example 9, as shown below.

A base layer 104 used in this example was a quartz glass having a diameter 100 mm, a thickness of 1 mm, and a Young's modulus of 72 GPa. A silicone resin die having a thickness of 100 μm and bearing an opened hole 80 mm in diameter was placed on a surface of the base layer 104, and an acrylic photocurable resin for buffer layer 103 was poured into the hole by casting, followed by curing of the poured resin through irradiation with an ultraviolet ray to form a buffer layer 103. The acrylic photocurable resin for the buffer layer 103 had a Young's modulus after ultraviolet curing of 10 MPa. Next, a photocurable unsaturated polyester resin for pattern layer 102 was dispensed and dropped to the surface of the buffer layer 103; a silicon master mold was placed thereon; and an ultraviolet ray was applied from the base layer 104 side while pressurizing to form a pattern layer 102 having a thickness of 42 μm. The master mold had a trench pattern having a width of 50 nm, a depth of 80 nm, and a pitch of 100 nm. The photocurable unsaturated polyester resin used for the pattern layer 102 had a Young's modulus after ultraviolet curing of 2.4 GPa. The pattern layer 102 was thereafter released from the master mold to give a stamper 101 having a three-layered structure including the pattern layer 102, the buffer layer 103 and the base layer 104.

Next, using a substrate having a bump with a height h of 1 μm, the distance Lc from the edge of the bump to the outer periphery of a transfer failure region was measured, this was divided by the height h to give an Lc/h, and the Lc/h was evaluated as the bump conformity. In this example, the Lc/h was found to be 99.7. The stamper did not show breakage after transfer.

### Example 11

A three-layered stamper according to another embodiment having the following configuration was produced by the following method, and the bump conformity of the stamper was determined by the procedure of Example 9, as shown below.

A base layer 104 used in this example was a quartz glass having a diameter of 100 mm, a thickness of 1 mm, and a Young's modulus of 72 GPa. A silicone resin die having a thickness of 100 μm and bearing an opened hole 80 mm in diameter was placed on a surface of the base layer 104; an acrylic photocurable resin for buffer layer 103 was dispensed and dropped to the exposed surface of the base layer 104; and an ultraviolet ray was applied from the base layer 104 side while pressurizing to form a buffer layer 103 having a thickness of 4.2 μm. The acrylic resin used for the buffer layer 103 had a Young's modulus after ultraviolet curing of 100 MPa. Next, a photocurable unsaturated polyester resin for pattern layer 102 was dispensed and dropped to the surface of the buffer layer 103; a silicon master mold was placed thereon; and an ultraviolet ray was applied from the base layer 104 side while pressurizing to form a pattern layer 102 having a thickness of 42 μm. The master mold had a trench pattern having a width of 50 nm, a depth of 80 nm, and a pitch of 100 nm. The photocurable unsaturated polyester resin used for the pattern layer 102 had a Young's modulus after ultraviolet curing of 2.4 GPa. The pattern layer 102 was thereafter released from the master mold to give a stamper 101 having a three-layered structure including the pattern layer 102, the buffer layer 103 and the base layer 104.

Next, using a substrate having a bump with a height h of 10 μm, the distance Lc from the edge of the bump to the outer periphery of a transfer failure region was measured, this was divided by the height h to give an Lc/h, and the Lc/h was evaluated as the bump conformity. In this example, the Lc/h was found to be 100. The stamper did not show breakage after transfer.

### Example 12

A three-layered stamper according to another embodiment having the following configuration was produced by the following method, and the bump conformity of the stamper was determined by the procedure of Example 9, as shown below.

A base layer 104 used in this example was a quartz glass having a diameter of 100 mm, a thickness of 1 mm, and a Young's modulus of 72 GPa. A silicone resin die having a thickness of 1 mm and bearing an opened hole 80 mm in diameter was placed on a surface of the base layer 104, and an acrylic photocurable resin for buffer layer 103 was poured into the hole by casting, followed by curing of the poured resin through irradiation with an ultraviolet ray to form a buffer layer 103. The acrylic photocurable resin for the buffer layer 103 had a Young's modulus after ultraviolet curing of 1.6 GPa. Next, a photocurable unsaturated polyester resin for pattern layer 102 was dispensed and dropped to the surface of the buffer layer 103; a silicon master mold was placed thereon; and an ultraviolet ray was applied from the base layer 104 side while pressurizing to form a pattern layer 102 having a thickness of 0.1 μm. The master mold had a trench pattern having a width of 50 nm, a depth of 80 nm, and a pitch of 100 nm. The photocurable unsaturated polyester resin used for the pattern layer 102 had a Young's modulus after ultraviolet curing of 2.4 GPa. The pattern layer 102 was thereafter released from the master mold to give a stamper 101 having a three-layered structure including the pattern layer 102, the buffer layer 103 and the base layer 104.

Next, using a substrate having a bump with a height h of 1 μm, the distance Lc from the edge of the bump to the outer periphery of a transfer failure region was measured, this was divided by the height h to give an Lc/h, and the Lc/h was evaluated as the bump conformity. In this example, the Lc/h was found to be 100. The stamper did not show breakage after transfer.

Table 2 shows the conditions and parameters of the respective layers, determined bump conformities, and the presence or absence of stamper breakage after the pattern transfer, in the stampers according to Examples 9 to 12. In the table, the symbol O represents “absence of breakage” and the symbol x represents “presence of breakage”.

TABLE 2

| | | Example 9 | Example 10 | Example 11 | Example 12 |
|---|---|---|---|---|---|
| Base layer | Young's modulus (MPa) | 72000 | 72000 | 72000 | 72000 |
| | Thickness (μm) | 1000 | 1000 | 1000 | 1000 |
| Buffer layer | Young's modulus (MPa) | 10 | 10 | 100 | 1500 |
| | Thickness (μm) | 1000 | 100 | 4.2 | 1000 |
| Pattern layer | Young's modulus (MPa) | 2400 | 2400 | 2400 | 2400 |
| | Thickness (μm) | 0.1 | 42 | 0.1 | 0.1 |

| | | | | |
|---|---|---|---|---|
| Bump height h (μm) | 10 | 1 | 10 | 1 |
| Bump conformity Lc/h | 2.7 | 99.7 | 100 | 100 |
| Presence or absence of stamper | ◯ | ◯ | ◯ | ◯ |
| breakage after transfer | | | | |
| (◯: absence, X: presence) | | | | |

Determination results of the bump conformity and the presence or absence of stamper breakage in the stampers according to the present invention

### Comparative Example 4

Another three-layered stamper having the following configuration was produced by the following method, and the bump conformity of the stamper was determined by the procedure of Example 9, as shown below.

A base layer 104 used in this comparative example was a quartz glass having a diameter of 100 mm, a thickness of 1 mm, and a Young's modulus of 72 GPa. A silicone resin die having a thickness of 1 mm and bearing an opened hole 80 mm in diameter was placed on a surface of the base layer 104, and an acrylic photocurable resin for buffer layer 103 was poured into the hole by casting, followed by curing of the poured resin through irradiation with an ultraviolet ray to form a buffer layer 103. The acrylic photocurable resin for the buffer layer 103 had a Young's modulus after ultraviolet curing of 10 MPa. Next, a photocurable unsaturated polyester resin for pattern layer 102 was dispensed and dropped to the surface of the buffer layer 103; a silicon master mold was placed thereon; and an ultraviolet ray was applied from the base layer 104 side while pressurizing to form a pattern layer 102 having a thickness. The master mold had a trench pattern having a width of 50 nm, a depth of 30 nm, and a pitch of 100 nm. The photocurable unsaturated polyester resin used for the pattern layer 102 had a Young's modulus after ultraviolet curing of 2.4 GPa. The pattern layer 102 was thereafter released from the master mold to give a stamper 101 having a three-layered structure including the pattern layer 102, the buffer layer 103 and the base layer 104.

Next, using a substrate having a bump with a height h of 10 μm, the distance Lc from the edge of the bump to the outer periphery of a transfer failure region was measured, this was divided by the height h to give an Lc/h, and the Lc/h was evaluated as the bump conformity. In this comparative example, the Lc/h was found to be 2, but the stamper showed breakage after transfer.

### Comparative Example 5

Another three-layered stamper having the following configuration was produced by the following method, and the bump conformity of the stamper was determined by the procedure of Example 9, as shown below.

A base layer 104 used in this comparative example was a quartz glass having a diameter of 100 mm, a thickness of 1 mm, and a Young's modulus of 72 GPa. A silicone resin die having a thickness of 100 μm and bearing an opened hole 80 mm in diameter was placed on a surface of the base layer 104, and an acrylic photocurable resin for buffer layer 103 was poured into the hole by casting, followed by curing of the poured resin through irradiation with an ultraviolet ray to form a buffer layer 103. The acrylic photocurable resin for the buffer layer 103 had a Young's modulus after ultraviolet curing of 10 MPa. Next, a photocurable unsaturated polyester resin for pattern layer 102 was dispensed and dropped to the surface of the buffer layer 103; a silicon master mold was placed thereon; and an ultraviolet ray was applied from the base layer 104 side while pressurizing to form a pattern layer 102 having a thickness of 60 μm. The master mold had a trench pattern having a width of 50 nm, a depth of 80 nm, and a pitch of 100 nm. The photocurable unsaturated polyester resin used for the pattern layer 102 had a Young's modulus after ultraviolet curing of 2.4 GPa. The pattern layer 102 was thereafter released from the master mold to give a stamper 101 having a three-layered structure including the pattern layer 102, the buffer layer 103 and the base layer 104.

Next, using a substrate having a bump with a height h of 1 μm, the distance Lc from the edge of the bump to the outer periphery of a transfer failure region was measured, this was divided by the height h to give an Lc/h, and the Lc/h was evaluated as the bump conformity. In this comparative example, the stamper after transfer showed no failure, but the Lc/h was found to be 122.5.

### Comparative Example 6

Another three-layered stamper having the following configuration was produced by the following method, and the bump conformity of the stamper was determined by the procedure of Example 9, as shown below.

A base layer 104 used in this comparative example was a quartz glass having a diameter of 100 mm, a thickness of 1 mm, and a Young's modulus of 72 GPa. A silicone resin die having a thickness of 100 μm and bearing an opened hole 80 mm in diameter was placed on a surface of the base layer 104; an acrylic photocurable resin for buffer layer 103 was dispensed and dropped to the exposed surface of the base layer 104; and an ultraviolet ray was applied from the base layer 104 side while pressurizing to form a buffer layer 103 having a thickness of 4 μm. The acrylic resin used for the buffer layer 103 had a Young's modulus after ultraviolet curing of 100 MPa. Next, a photocurable unsaturated polyester resin for pattern layer 102 was dispensed and dropped to the surface of the buffer layer 103; a silicon master mold was placed thereon; and, while pressurizing so as to allow the pattern layer 102 to have a thickness of 0.1 μm, an ultraviolet ray was applied from the base layer 104 side to form the pattern layer 102. The master mold had a trench pattern having a width of 50 nm, a depth of 80 nm, and a pitch of 100 nm. The photocurable unsaturated polyester resin used for the pattern layer 102 had a Young's modulus after ultraviolet curing of 2.4 GPa. The pattern layer 102 was thereafter released from the master mold to give a stamper 101 having a three-layered structure including the pattern layer 102, the buffer layer 103 and the base layer 104.

Next, using a substrate having a bump with a height h of 10 μm, the distance Lc from the edge of the bump to the outer periphery of a transfer failure region was measured, this was divided by the height h to give an Lc/h, and the Lc/h was evaluated as the bump conformity. In this example, the stamper after transfer showed no failure, but the Lc/h was found to be 105.

### Comparative Example 7

Another three-layered stamper having the following configuration was produced by the following method, and the bump conformity of the stamper was determined by the procedure of Example 9, as shown below.

A base layer 104 used in this comparative example was a quartz glass having a diameter of 100 mm, a thickness of 1 mm, and a Young's modulus of 72 GPa. A silicone resin die having a thickness of 1 mm and bearing an opened hole 80 mm in diameter was placed on a surface of the base layer 104, and an acrylic photocurable resin for buffer layer 103 was poured into the hole by casting, followed by curing of the poured resin through irradiation with an ultraviolet ray to form a buffer layer 103. The acrylic photocurable resin for the buffer layer 103 had a Young's modulus after ultraviolet curing of 2.2 GPa. Next, a photocurable unsaturated polyester resin for pattern layer 102 was dispensed and dropped to the surface of the buffer layer 103; a silicon master mold was placed thereon; and an ultraviolet ray was applied from the base layer 104 side while pressurizing to form a pattern layer 102 having a thickness of 0.1 μm. The master mold had a trench pattern having a width of 50 nm, a depth of 80 nm, and a pitch of 100 nm. The photocurable unsaturated polyester resin used for the pattern layer 102 had a Young's modulus after ultraviolet curing of 2.4 GPa. The pattern layer 102 was thereafter released from the master mold to give a stamper 101 having a three-layered structure including the pattern layer 102, the buffer layer 103 and the base layer 104.

Next, using a substrate having a bump with a height h of 1 μm, the distance Lc from the edge of the bump to the outer periphery of a transfer failure region was measured, this was divided by the height h to give an Lc/h, and the Lc/h was evaluated as the bump conformity. In this comparative example, the stamper after transfer showed no failure, but the Lc/h was found to be 148.4.

Table 3 shows the conditions and parameters of the respective layers, determined bump conformities, and the presence or absence of stamper breakage after the pattern transfer, in the stampers according to Comparative Examples 4 to 7. In the table, the symbol O represents “absence of breakage” and the symbol x represents “presence of breakage”.

TABLE 3

| | | Com. Ex. 4 | Com. Ex. 5 | Com. Ex. 6 | Com. Ex. 7 |
|---|---|---|---|---|---|
| Base layer | Young's modulus (MPa) | 72000 | 72000 | 72000 | 72000 |
| | Thickness (μm) | 1000 | 1000 | 1000 | 1000 |
| Buffer layer | Young's modulus (MPa) | 10 | 10 | 100 | 1600 |
| | Thickness (μm) | 1000 | 100 | 4 | 1000 |
| Pattern layer | Young's modulus (MPa) | 2400 | 2400 | 2400 | 2400 |
| | Thickness (μm) | 0.05 | 43 | 0.1 | 0.1 |

| | | | | |
|---|---|---|---|---|
| Bump height h (μm) | 10 | 1 | 10 | 1 |
| Bump conformity Lc/h | 2.0 | 101 | 105 | 108.6 |
| Presence or absence of stamper | X | ◯ | ◯ | ◯ |
| breakage after transfer | | | | |
| (◯: absence, X: presence) | | | | |

Determination results of the bump conformity and the presence or absence of stamper breakage in the stampers according to Comparative Examples 4 to 7

### Comparative Example 8 to Comparative Example 11

Bump conformities of stampers each having a single-layer structure as disclosed in Patent Literature 2 were determined by the procedure of Example 9. A material having a Young's modulus of 1.9 GPa was used in these comparative examples. A substrate having a cylindrical bump with a height of 1 μm was used. The bump conformities determined on the stampers having different thicknesses are shown in Table 4.

TABLE 4

| | Com. | Com. | Com. | Com. |
|---|---|---|---|---|
| | Ex. 8 | Ex. 9 | Ex. 10 | Ex. 11 |
| Thickness (μm) | 50 | 100 | 500 | 1000 |
| Bump height h (μm) | 1 | 1 | 1 | 1 |
| Bump conformity Lc/h | 179 | 103 | 124 | 125 |

Determination results of the bump conformities of the stampers according to Comparative Examples 8 to 11

### Example 13

A four-layered stamper having a structure corresponding to the three-layered stamper, except for further having an intermediate layer between the pattern layer and the buffer layer will be illustrated in this example. Initially, the structure and production method of the stamper used in this example will be explained.

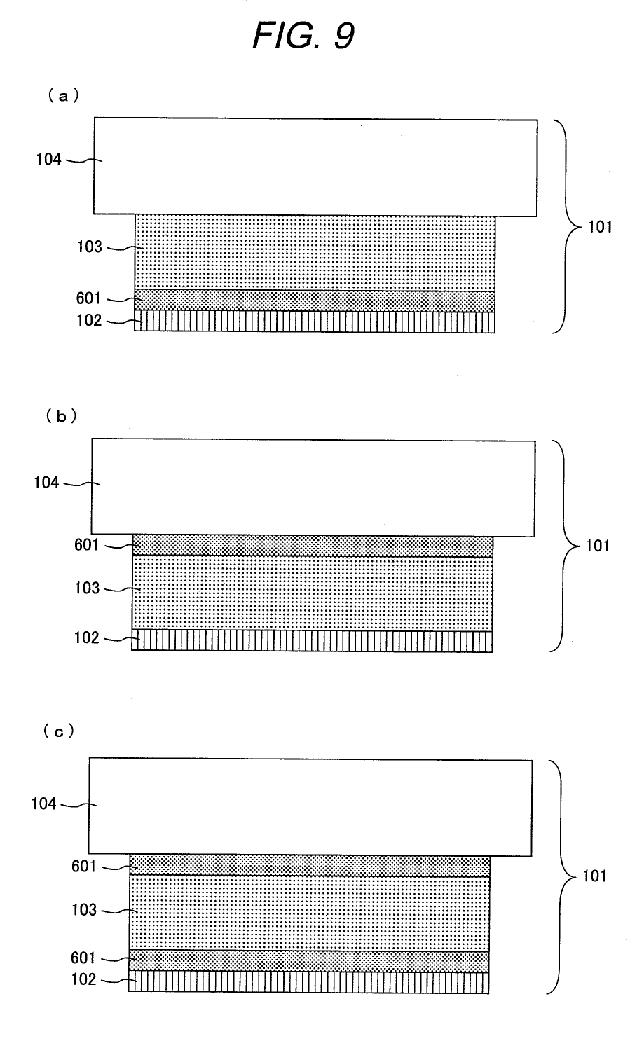

FIG. 9 depicts schematic diagrams of the structures of stampers according to embodiments of the present invention. The stamper 101 includes three layers, i.e., a pattern layer 102, a buffer layer 103 and a base layer 104 differing in elasticity from one another and further includes one or more intermediate layers 601 arranged at least one of between the pattern layer 102 and the buffer layer 103 and between the buffer layer 103 and the base layer 104, as illustrated in FIG. 9 (a) to (c). The pattern layer 102 has a fine pattern on a surface thereof. A stamper having the structure illustrated in FIG. 9 (a) was used in this example.

The intermediate layer 601 is arranged so as to allow the pattern layer 102 to be exchangeable.

The base layer 104 used herein was a quartz glass having a diameter of 100 mm, a thickness of 1 mm, and a Young's modulus of 72 GPa. A silicone resin die having a thickness of 1 mm and bearing an opened hole 80 mm in diameter was placed on a surface of the base layer 104, and an acrylic photocurable resin for buffer layer 103 was poured into the hole by casting, followed by curing of the poured resin through the application of an ultraviolet ray, to form a buffer layer 103. The acrylic photocurable resin for the buffer layer 103 had a Young's modulus after ultraviolet curing of 10 MPa. A poly(ethylene terephthalate) (PET) sheet having a diameter of 82 mm and a thickness of 5 μm for intermediate layer 601 was brought into intimate contact with the cured buffer layer 103. A photocurable unsaturated polyester resin for pattern layer 102 was dispensed and dropped thereto; a silicon master mold was placed thereon; and an ultraviolet ray was applied from the base layer 104 side while pressurizing to form a pattern layer 102 having a thickness of 1 μm on the intermediate layer 601. The master mold had a trench pattern having a width of 50 nm, a depth of 80 nm, and a pitch of 100 nm. The unsaturated polyester resin used for the pattern layer 102 had a Young's modulus after ultraviolet curing of 2.4 GPa. The pattern layer 102 was thereafter released from the master mold to give a stamper 101 having a three-layered structure including the pattern layer 102, the buffer layer 103 and the base layer 104. In this example, prior to the formation of the intermediate layer 601 and the pattern layer 102 which will constitute an exchangeable unit 701, the intermediate layer 601 in the exchangeable unit 701 was brought into intimate contact with the buffer layer 103 in a reusable unit 702. However, the step of bringing the exchangeable unit 701 and the reusable unit 702 into intimate contact with each other may be performed during the formation of the exchangeable unit 701 or after the formation of the exchangeable unit 701.

Next, the bump conformity of the stamper was determined by the procedure of Example 9, and the result is shown below. A object to be transferred 1010 used in this example was one including a substrate to be transferred 1011 having a bump with a height of 1 μm on a surface thereof; and a photocurable resin 1012 applied to the surface of the substrate by dispensing. In this example, the bump conformity Lc/h was found to be 27. The stamper did not show breakage after transfer.

Next, a method for performing transfer multiple times while exchanging a part of the stamper according to this embodiment and reusing the residual part will be illustrated.

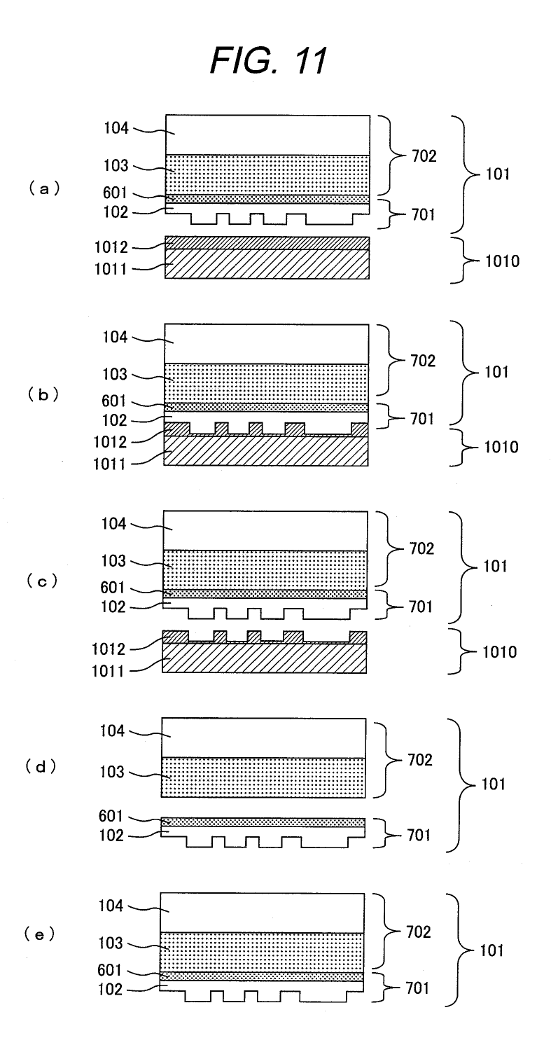

FIG. 11 depicts schematic views of a nanoimprinting process according to this embodiment.

FIG. 11 (a) is a cross-sectional enlarged view of the shapes of the stamper 101 and of an object to be transferred 1010 before being contacted with each other for transfer. The object to be transferred 1010 includes a substrate to be transferred 1011, and applied on a surface thereof, a photocurable resin to be transferred 1012. In this example, the exchangeable unit 701 and the reusable unit 702 are mechanically fixed with each other (not shown) in the state of FIG. 11 (a).

From the state in FIG. 11 (a), the stamper 101 and the resin to be transferred 1012 are contacted with each other, and the stamper 101 and the object to be transferred 1010 are pressurized at a pressure of 1 MPa, as illustrated in FIG. 11 (b). An ultraviolet ray is applied from above the base layer 104 to cure the resin to be transferred 1012, whereby a pattern with inverse of the asperity geometry of the pattern layer 102 is transferred to the resin to be transferred 1012.

After completion of the transfer, the stamper 101 is released (separated) from the object to be transferred 1010 as in FIG. 11 (c).

Next, with reference to FIG. 11 (d), the exchangeable unit 701 and the reusable unit 702, which have been in intimate contact with each other, are detached from each other. In this example, this step was performed by removing the mechanical fixation between the exchangeable unit 701 and the reusable unit 702; inserting a wedge-shaped member into between the intermediate layer 601 and the buffer layer 103; and peeling off the exchangeable unit 701 from the reusable unit 702.

Finally, with reference to FIG. 11 (e), an intermediate layer 601 in another exchangeable unit 701 is brought into intimate contact with the buffer layer 103 in the reusable unit 702, and a pattern layer 102 is laterally mechanically fixed via the intermediate layer 601 and the buffer layer 103 to the base layer 104. The ways to detach and to attach the exchangeable unit 701 and the reusable unit 702 are not limited to the ways described in this example.

The above technique eliminates the need of exchanging the whole stamper after each transfer procedure and enables low-cost transfer processes.

### Example 14

This example illustrates another method for carrying out transfer multiple times while exchanging part of a stamper according to the present invention and reusing the residual part. Initially, the structure and production method of a stamper for use in this example will be illustrated.

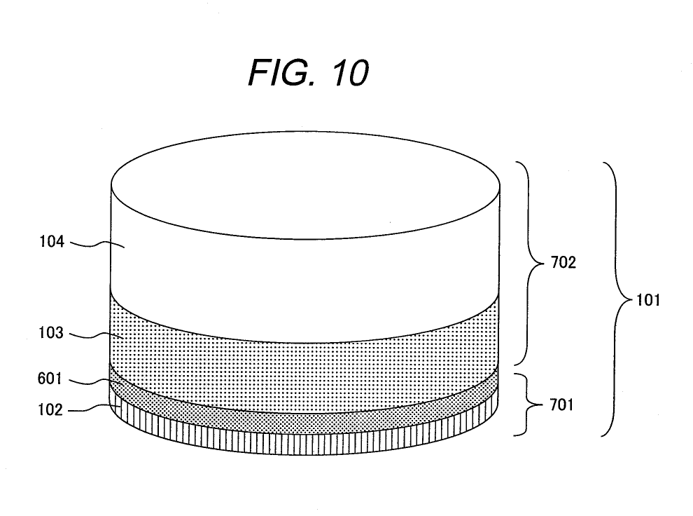

FIG. 10 is a schematic diagram of the stamper used in this example. The stamper 101 includes an exchangeable unit 701 and a reusable unit 702, in which the exchangeable unit 701 includes a pattern layer 102 and an intermediate layer 601; and the reusable unit 702 includes a buffer layer 103 and a base layer 104.

The base layer 104 used herein was a quartz glass having a diameter of 100 mm, a thickness of 1 mm, and a Young's modulus of 72 GPa. A silicone resin die having a thickness of 1 mm and bearing an opened hole 80 mm in diameter was placed on a surface of the base layer 104; and an acrylic photocurable resin for buffer layer 103 was poured into the hole by casting, followed by curing of the resin through irradiation with an ultraviolet ray, to form a buffer layer 103. The acrylic photocurable resin for the buffer layer 103 had a Young's modulus after ultraviolet curing of 10 MPa.

After the curing of the buffer layer 103, an adhesive sheet and a PET sheet, both provided for the intermediate layer 601, were sequentially placed thereon. The adhesive sheet irreversibly loses its adhesiveness by heating, and the PET sheet had a diameter of 82 mm and a thickness of 5 μm. A photocurable unsaturated polyester resin for the pattern layer 102 was dispensed and dropped onto the PET sheet; a silicon master mold was placed thereon; and an ultraviolet ray was applied from the base layer 104 side while pressurizing to form the pattern layer 102 having a thickness of 1 μm on the intermediate layer 601. The master mold had a trench pattern having a width of 50 nm, a depth of 80 nm, and a pitch of 100 nm. The unsaturated polyester resin used for the pattern layer 102 had a Young's modulus after ultraviolet curing of 2.4 GPa.

The pattern layer 102 was thereafter released from the master mold to yield the stamper 101 having a four-layered structure including the pattern layer 102, the intermediate layer 601, the buffer layer 103 and the base layer 104. In this example, the intimate contact of the intermediate layer 601 in the exchangeable unit 701 with the buffer layer 103 in the reusable unit 702 was carried out during the formation of the intermediate layer 601 and the pattern layer 102 to constitute the exchangeable unit 701. However, the step of bringing the exchangeable unit 701 and the reusable unit 702 into intimate contact with each other may be performed after the formation of the exchangeable unit 701.

Next, the method for carrying out transfer multiple times while exchanging part of a stamper according to the present invention and reusing the residual part will be described.

FIG. 11 depicts schematic views of a nanoimprinting process according to this embodiment.

FIG. 11 (a) is a cross-sectional enlarged view of the shapes of the stamper 101 and of an object to be transferred 1010 before being contacted with each other for transfer. The object to be transferred 1010 includes a substrate to be transferred 1011, and applied on a surface thereof, a photocurable resin to be transferred 1012.

From the state in FIG. 11 (a), the stamper 101 and the resin to be transferred 1012 are contacted with each other, and the stamper 101 and the object to be transferred 1010 are pressed against each other at a pressure of 1 MPa, as illustrated in FIG. 11 (b). An ultraviolet ray is applied from above the base layer 104 to cure the resin to be transferred 1012, whereby a pattern with inverse of the asperity geometry of the pattern layer 102 is transferred to the resin to be transferred 1012.

After completion of the transfer, the stamper 101 is separated from the object to be transferred 1010 as in FIG. 11 (c).

Next, with reference to FIG. 11 (d), the exchangeable unit 701 and the reusable unit 702, which have been in intimate contact with each other, are detached from each other. In this example, this step was performed by heating the stamper to allow the adhesive sheet in the intermediate layer 601 to lose its adhesiveness; inserting a wedge-shaped member into between the intermediate layer 601 and the buffer layer 103; and thereby peeling off the exchangeable unit 701 from reusable unit 702.

Finally, with reference to FIG. 11 (e), an adhesive sheet surface of an intermediate layer 601 in another exchangeable unit 701 is brought into intimate contact with the buffer layer 103 in the reusable unit 702.

The above technique eliminates the need of exchanging the whole stamper after each transfer procedure and enables low-cost transfer processes.

### Example 15

This example illustrates a method for carrying out transfer multiple times while exchanging an exchangeable unit 701 of a stamper (see FIG. 10) prepared by the procedure of Example 13, and reusing a reusable unit 702.

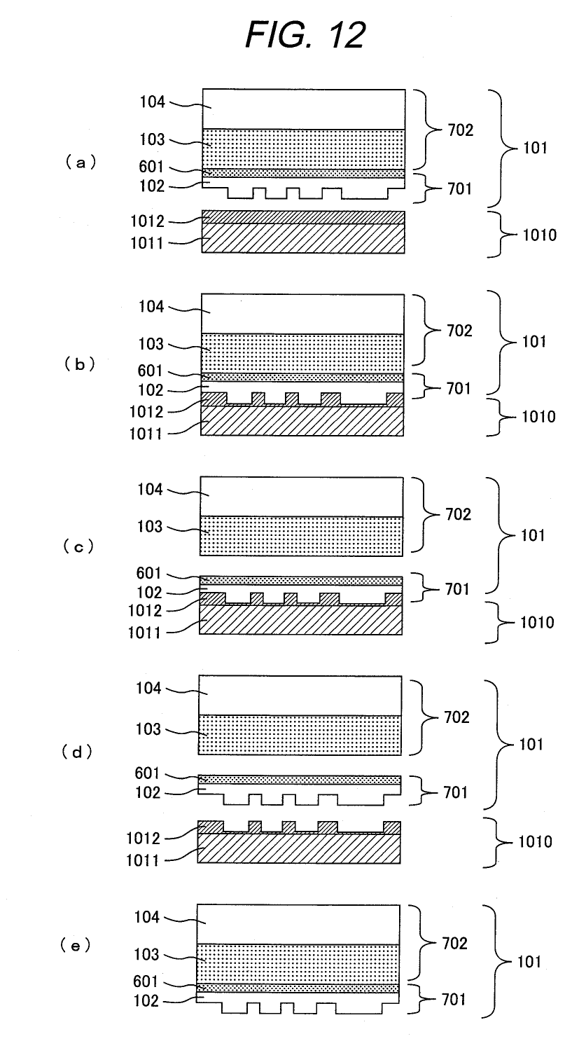

FIG. 12 depicts schematic views of a nanoimprinting process according to this example.

FIG. 12 (a) is a cross-sectional enlarged view of the shapes of the stamper 101 and of an object to be transferred 1010 before being contacted with each other for transfer. The object to be transferred 1010 includes a substrate to be transferred 1011, and applied on a surface thereof, a photocurable resin to be transferred 1012. In this example, the exchangeable unit 701 and the reusable unit 702 are mechanically fixed with each other (not shown) in the state of FIG. 12 (a).

From the state in FIG. 12 (a), the stamper 101 and the resin to be transferred 1012 are contacted with each other, and the stamper 101 and the object to be transferred 1010 are pressurized at a pressure of 1 MPa, as illustrated in FIG. 12 (b). An ultraviolet ray is applied from a side of the base layer 104 opposite to the pattern layer to cure the resin to be transferred 1012, whereby a pattern with inverse of the asperity geometry of the pattern layer 102 is transferred to the resin to be transferred 1012.

Then, the mechanical fixation between the exchangeable unit 701 and the reusable unit 702 is removed, whereby the exchangeable unit 701 and the object to be transferred 1010 are detached from the reusable unit 702 as in FIG. 12 (c).

Thereafter, the exchangeable unit 701 is released from the object to be transferred 1010 to find that a pattern with inverse of the asperity geometry of the pattern layer 102 is transferred to the resin to be transferred 1012 as in FIG. 12 (d).

Finally, with reference to FIG. 12 (e), an intermediate layer 601 in another exchangeable unit 701 is brought into intimate contact with the buffer layer 103 in the reusable unit 702, and the exchangeable unit 701 and the reusable unit 702 are mechanically fixed with each other.

The above technique eliminates the need of exchanging the whole stamper after each transfer procedure and enables low-cost transfer processes.

### Example 16

This example illustrates another method for carrying out transfer multiple times while exchanging part of a stamper according to the present invention and reusing the residual part. Initially, the structure and production method of a stamper for use in this example will be illustrated.

FIG. 10 is a schematic diagram of the stamper used in this example. The stamper 101 includes an exchangeable unit 701 and a reusable unit 702, in which the exchangeable unit 701 includes a pattern layer 102 and an intermediate layer 601; and the reusable unit 702 includes a buffer layer 103 and a base layer 104.

The base layer 104 used herein was a quartz glass having a diameter of 100 mm, a thickness of 1 mm, and a Young's modulus of 72 GPa. A silicone resin die having a thickness of 1 mm and bearing an opened hole 80 mm in diameter was placed on a surface of the base layer 104; and an acrylic photocurable resin for the buffer layer 103 was poured into the hole by casting, followed by curing of the resin through irradiation with an ultraviolet ray, to form the buffer layer 103. The acrylic photocurable resin for the buffer layer 103 had a Young's modulus after ultraviolet curing of 10 MPa. After the curing of the buffer layer 103, a PET sheet having a diameter of 82 mm and a thickness of 5 μm was placed on the buffer layer 103. A photocurable unsaturated polyester resin for the pattern layer 102 was dispensed and dropped onto the PET sheet; a silicon master mold was placed thereon; and, while pressurizing so as to allow the pattern layer 102 to have a thickness of 1 μm, an ultraviolet ray was applied to form the pattern layer 102 on the PET film. The master mold had a trench pattern having a width of 50 nm, a depth of 80 nm, and a pitch of 100 nm. The unsaturated polyester resin used for the pattern layer 102 had a Young's modulus after ultraviolet curing of 2.4 GPa. The pattern layer 102 was thereafter released (separated) from the master mold; an adhesive sheet was placed on another surface of the PET sheet opposite to the pattern layer; and the adhesive sheet was adhered (bonded) to another side of the buffer layer 103 opposite to the base layer 104. The adhesive sheet loses its adhesiveness by the application of an ultraviolet ray. According to this example, the two layers of the PET sheet and the adhesive sheet constitutes an intermediate layer 601. Thus, a stamper 101 including the pattern layer 102, the two-layered intermediate layer 601, the buffer layer 103 and the base layer 104 was obtained.

Next, the method for carrying out transfer multiple times while exchanging part of a stamper according to the present invention and reusing the residual part will be described.

FIG. 12 depicts schematic views of a nanoimprinting process according to this embodiment.

FIG. 12 (a) is a cross-sectional enlarged view of the shapes of the stamper 101 and of an object to be transferred 1010 before being contacted with each other for transfer. The object to be transferred 1010 includes a substrate to be transferred 1011, and applied on a surface thereof, a photocurable resin to be transferred 1012.

From the state in FIG. 12 (a), the stamper 101 and the resin to be transferred 1012 are contacted with each other, and the stamper 101 and the object to be transferred 1010 are pressed against each other at a pressure of 1 MPa, as illustrated in FIG. 12 (b). An ultraviolet ray is applied from above the base layer 104 to cure the resin to be transferred 1012, whereby a pattern with inverse of the asperity geometry of the pattern layer 102 is transferred to the resin to be transferred 1012. In this process, the irreversible adhesive sheet in the intermediate layer 601 loses its adhesiveness by the application of an ultraviolet ray.

After the completion of transfer, the exchangeable unit 701 and the object to be transferred 1010 are detached from the reusable unit 702 as in FIG. 12 (c).

Thereafter, the exchangeable unit 701 is released from the object to be transferred 1010 to find that a pattern with inverse of the asperity geometry of the pattern layer 102 is transferred to the resin to be transferred 1012, as in FIG. 12 (d).

Finally, an adhesive sheet contained in an intermediate layer 601 of another exchangeable unit 701 is bonded to the buffer layer 103 of the reusable unit 702, as in FIG. 12 (e).

The above technique eliminates the need of exchanging the whole stamper after each transfer procedure and enables low-cost transfer processes.

### INDUSTRIAL APPLICABILITY

The fine structures and stampers for imprinting both according to the present invention are applicable to apparatuses for processing fine patterns, as needed typically in semiconductor devices.

### EXPLANATION OF REFERENCES

1 supporting member
2 resin composition
3 master mold
4 pattern layer
5 fine structure
6 electroless nickel coating
7 nickel replica mold
8 material composition for buffer layer
9 flat plate
10 buffer layer
11 release layer
12 substrate to be transferred
13 simulated bump
14 photocurable resin
15 resinous replica stamper
101 stamper
102 pattern layer
103 buffer layer
104 base layer
601 intermediate layer
701 exchangeable unit
702 reusable unit
1010 object to be transferred
1011 substrate to be transferred
1012 resin to be transferred

1. A fine structure comprising a supporting member; and a pattern layer having a fine asperity pattern formed on a surface thereof on the surface of the supporting member, wherein the pattern layer is made from a resin through curing of a resin composition containing a cationic-polymerization catalyst and two or more organic components having different functional groups, and wherein the supporting member and the pattern layer each transmit light having a wavelength of 365 nm or longer.

2. The fine structure according to claim 1, wherein the organic components each contain at least one functional group selected from the group consisting of epoxy groups, oxetanyl groups and vinyl ether groups.

3. The fine structure according to claim 2, wherein the resin composition contains substantially no solvent component.

4. The fine structure according to claim 2, wherein the organic components each have two or more functional groups per one molecule.

5. The fine structure according to claim 2, wherein one of the organic components is represented by following Structural Formula (1):

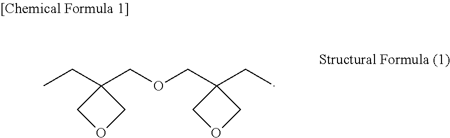

6. The fine structure according to claim 1, wherein the cationic-polymerization catalyst initiates the curing of the resin composition by the action of ultraviolet rays.

7. The fine structure according to claim 1, wherein the pattern layer has a glass transition temperature of 50° C. or higher.

8. The fine structure according to claim 1, further comprising a release layer on a surface of the pattern layer.

9. The fine structure according to claim 1, further comprising wherein the supporting member, the buffer layer and the pattern layer each transmit light having a wavelength of 365 nm or longer.

10-18. (canceled)

19. A method for producing a fine structure, the fine structure including a supporting member and a pattern layer having a fine asperity pattern formed on a surface thereof on the surface of the supporting member, the pattern layer made from a resin through curing of a resin composition containing a cationic-polymerization catalyst and two or more organic components having different functional groups, the method comprising the steps of applying the resin composition to a surface of the supporting member; pressing a master mold having fine concavities and convexities on a surface of the applied resin composition; curing the resin composition while pressing the master mold against the resin composition to thereby form the pattern layer; and detaching the master mold from the pattern layer.

20. The method for producing the fine structure according to claim 19, the method further comprising the steps of forming a buffer layer on a surface of the supporting member and thereafter applying the resin composition to a surface of the buffer layer.

21-41. (canceled)
